(19) United States
(12) Patent Application Publication
(10) Pub. No.: US 2024/0422669 A1
(43) Pub. Date: Dec. 19, 2024

(54) CELL SELECTION PROCEDURE ACCOUNTING FOR MEASUREMENT SCALING FACTOR IN LOW ACTIVITY STATE

(71) Applicant: Telefonaktiebolaget LM Ericsson (publ), Stockholm (SE)

(72) Inventors: Zhixun TANG, Beijing (CN); Muhammad Ali KAZMI, Sundbyberg (SE); Santhan THANGARASA, Vällingby (SE); Kazuyoshi UESAKA, Kawasaki Kanagawa (JP); Zhanxian WANG, Täby (SE)

(21) Appl. No.: 18/703,457

(22) PCT Filed: Oct. 21, 2022
(86) PCT No.: PCT/EP2022/079412

§ 371 Date: Apr. 22, 2024

(30) Foreign Application Priority Data
Oct. 22, 2021 (WO) PCT/CN2021/125674

(51) Int. Cl. H04W 52/02; H04W 48/16; H04W 48/20

(52) U.S. Cl. CPC H04W 52/0216; H04W 48/16; H04W 48/20

(57) ABSTRACT

A network node configured to communicate with a wireless device (WD) using at least one cell associated with the network node is described. The WD is configurable to operate in a discontinuous reception mode. The network node includes processing circuitry configured to determine a configuration for the WD to operate in the discontinuous reception mode. The determined configuration is usable by the WD to perform a cell selection procedure for a network if the WD has not found at least one suitable cell based on a second measurement performed within a second time period which is based at least in part on a scaling factor. The second measurement is associated with at least one second cell associated with the network node and is performed if the WD does not meet a cell selection criterion for a first cell. The configuration is transmitted to the WD.

### TECHNICAL FIELD

The present disclosure relates to wireless communications, and in particular, to cell selection procedures.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

### RedCap

5G was introduced in Release 15 of the 3GPP standard and is designed to increase speed, reduce latency, and improve flexibility of wireless services. The initial release of 5G in 3GPP Release 15 is Optimized for Mobile Broadband (MBB) and Ultra-Reliable and Low Latency Communication (URLLC). MBB and URLLC services require very high data rates and/or low latency and therefore puts high requirements on the WD. To enable 5G to be used for other services with more relaxed performance requirements a new low complexity WD type is introduced in 3GPP Release 17, described as reduced capability NR devices (RedCap). The low complexity WD type is particularly suited for Machine Type Communication (MTC) services such as wireless sensors or video surveillance but can also be used for MBB services with lower performance requirements such as wearables. Further, the low complexity WD has reduced capabilities compared to a 3GPP Release 15 NR WD such as the possibility of supporting lower bandwidth compared to what is currently required for a NR WD and the possibility of supporting only one reception (Rx) branch and one Multiple Input Multiple Output (MIMO) layer (e.g., in 3GPP RAN (“RP”) RP-210918).

eDRX Cycle Operation

In NR, enhanced Discontinuous Reception (eDRX) cycle is being specified for the WD in RRC_IDLE and RRC_INACTIVE. The purpose of eDRX cycle is further enable WD power saving even more than achieved by the WD when configured only with DRX cycle. The eDRX ranges between few seconds to several minutes or even hours. In one example, eDRX cycle may range from 5.12 seconds (i.e., shortest eDRX) up to 10485.76 s (i.e., largest eDRX). eDRX cycle may also be a multiple of 1.28 seconds which is a typical DRX cycle used in idle and inactive states.

eDRX configuration parameters are negotiated between the WD and the network node via higher layer signaling, e.g., via non-access stratum (NAS) messages. During the negotiation the network node transmits eDRX parameters, which may comprise eDRX cycle length, paging time window (PTW), hyper system frame number (H-SFN), paging H-SFN (PH), etc.

H-SFN comprises multiple System Frame Number (SFN) cycles as shown in FIG. 1. A SFN cycle is a counter which initializes after a certain number of frames. In one example, SFN cycle comprising of 1024 frames, i.e., varies from 0 to 1023. H-SFN is a frame structure on top of the legacy SFN structure, where each H-SFN value corresponds to a cycle of legacy frames (e.g., 1024 frames), and one H-SFN cycle contains X1 number of SFN cycles, e.g., X1=1024. The network/network node (e.g., elements of a core network such as MMEs, BS, gNodeBs, etc.) have the same H-SFN. Cells broadcast their H-SFN via system information, e.g., System Information Block (SIB). The boundaries of the eDRX acquisition period are determined by H-SFN values for which H-SFN mod X1=0, e.g., X1=256.

The WD may be configured with PTW by the network node such as an MME via NAS during an update, e.g., attach/tracking area update. The beginning of PTW is calculated by a pre-defined formula, as described below. Within a PTW, the WD is further configured with a legacy DRX as shown in the example of FIG. 2.

In one example, PTW is characterized by or determined by the WD using the following mechanism:
Paging H-SFN (PH) (calculated by a formula):
   H-SFN mod TeDRX=(UE_ID mod TeDRX);
   UE_ID: IMSI mod X2, e.g., X2=1024; and
   TeDRX: eDRX cycle of the UE, (TeDRX=1, 2, . . . , X3 in hyper-frames) and configured by upper layers, e.g., X3=256.
PTW start is calculated within PH as follows:
   The start of PTW is uniformly distributed across X4 (e.g., X4=4) paging starting points within the PH;
   PTW_start denotes the first radio frame of the PH that is part the paging window and has SFN satisfying the following equation:

$$SFN = X 3 * ieDRX ,$$

$$where$$

$$ieDRX = floor ( UE\_ID / TeDRX , H ) mod X 4$$

PTW_end is the last radio frame of the PTW and has SFN satisfying the following equation:

$$SFN = ( PW\_start + L * X 5 - X 6 ) mod X 2 , e . g . , X 5 = 100 , X 6 = 1 ,$$

$$where :$$

$$L = Paging Window length ( in seconds ) configured by upper layers e . g . , via RRC .$$

PTW length (configured by higher layers).
Some RAN2 agreements for eDRX in RedCap WDs are as follows:
eDRX feature is optional for any WD (including RedCap and non-RedCap WDs);
RAN2 considers the configuration as an invalid case, where INACTIVE eDRX cycle is configured, but IDLE eDRX cycle is not configured. Whether to capture this restriction in RAN2 specification has been left For Further Study (FFS);
RAN2 considers the configuration as invalid case, where INACTIVE eDRX cycle is longer than IDLE eDRX cycle. Whether to capture this restriction in RAN2 specification is FSS;
The maximum PTW length is 40.96s when IDLE eDRX cycle is longer than 10.24s;
The minimum PTW length is 1.28s, and the step length/granularity of PTW length is 1.28 when IDLE eDRX cycle is longer than 10.24s;
When IDLE eDRX cycle is longer than 10.24s, PH calculation formula defined in LTE is re-used, i.e.:
   PH_CN: H-SFN mod TeDRX,_CN,H=(UE_ID_H mod TeDRX_CN,H)
      where TeDRX_CN,H is equal to IDLE eDRX cycle.
When IDLE eDRX cycle is longer than 10.24s, CN PTW_end calculation formula defined in LTE is re-used, i.e.:
   PTW_end is radio frame satisfying SFN=(PTW_start+L*100 1) mod 1024,
      where L is PTW length configured by upper layers.

### Working Assumption

When IDLE eDRX cycle is longer than 10.24s, CN PTW_start calculation formula defined in LTE is re-used as the baseline, as described below. Whether CN PTW_start position could be configurable by network (e.g., network node) is FSS. Note: this formula would be revisited if INACTIVE eDRX cycle can be above 10.24s.

PTW_start denotes the first radio frame of the PH that is part of the PTW and has SFN satisfying the following equation:

$$SFN = 1024 / N * ieDRX ,$$

$$where$$

$$ieDRX = floor ( UE\_ID \_H / TeDRX , H ) mod N ;$$

$$FFS N = 4 or 8 , FFS if N can take other values .$$

### WD Measurements

The WD performs measurements on one or more DL and/or UL reference signal (RS) of one or more cells in different WD activity states e.g., RRC idle state, RRC inactive state. RRC connected state etc. A measured cell may belong to or operate on the same carrier frequency as of the serving cell (e.g., intra-frequency carrier) or may belong to or operate on different carrier frequency as of the serving cell (e.g., non-serving carrier frequency). A non-serving carrier may be referred to as inter-frequency carrier if the serving and measured cells belong to the same Radio Access Technology (RAT) bit different carriers. The non-serving carrier may be referred to as inter-RAT carrier if the serving and measured cells belong to different RATs. Examples of downlink RS are signals in Synchronization Signal (SS), Channel State information Reference Signal (CSI-RS), Cell specific Reference Signal (CRS), Demodulation Reference Signal (DMRS), Primary SS (PSS), Secondary SS (SSS), signals in SS/Physical Broadcast Channel (PBCH) block (SSB), Discovery Reference Signal (DRS), Positioning Reference Signal (PRS), etc. Examples of uplink Reference Signals (RS) are signals in Sounding Reference Signal (SRS), DMRS, etc.

Each SSB carries NR-PSS. NR-SSS and NR-PBCH in 4 successive symbols. One or multiple SSBs are transmitted in one SSB burst which is repeated with certain periodicity e.g., 5 ms, 10 ms, 20 ms, 40 ms, 80 ms and 160 ms. The WD is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g., serving cell's SFN), etc. Therefore, SMTC occasion may also occur with certain periodicity e.g., 5 ms, 10 ms, 20 ms, 40 ms, 80 ms and 160 ms.

Examples of measurements are cell identification (e.g., Physical Cell ID (PCI) acquisition, PSS/SSS detection, cell detection, cell search, etc), Reference Symbol Received Power (RSRP), Reference Symbol Received Quality (RSRQ), SS-RSRP, SS-RSRQ, Signal-to-Noise and Interference Ratio (SINR), RS-SINR, SS-SINR, CSI-RSRP, CSI-RSRQ, Received Signal Strength Indicator (RSSI), acquisition of System Information (SI), Cell Global ID (CGI) acquisition, Reference Signal Time Difference (RSTD), WD RX-TX time difference measurement, Radio Link Monitoring (RLM), which consists of Out of Synchronization (i.e., out of sync) detection and In Synchronization (i.e., in-sync) detection, etc.

The WD is typically configured by the network node, such as via RRC message, with measurement configuration and measurement reporting configuration e.g., measurement gap pattern, carrier frequency information, types of measurements (e.g., RSRP, etc.), higher layer filtering coefficient, time to trigger report, reporting mechanism (e.g., periodic, event triggered reporting, event triggered periodic reporting). The measurements are done for various purposes. Some example measurement purposes are: WD mobility (e.g., cell change, cell selection, cell reselection, handover, RRC connection re-establishment). WD positioning or location determination Self-Organizing Network (SON), Minimization of Drive Tests (MDT), Operation and Maintenance (O&M), network planning and optimization, etc.

WD Measurement Requirement for eDRX

In legacy LTE, the WD measurement requirement when WD is configured with eDRX is shown as follows.

TABLE 1
An example of T_{detect, EUTRAN}_{_{—}}_{Intra}, T_{measure, EUTRAN}_{_{—}}_{Intra} and
T_{evaluate, E-UTRAN}_{_{—}}ᵢₙₜᵣₐ for a WD configured with eDRX_IDLE cycle.

| eDRX_IDLE | | PTW length | T_{detect, EUTRAN}_{_{—}}_{Intra} | T_{measure, EUTRAN}_{_{—}}_{Intra} | T_{evaluate, E-UTRAN}_{_{—}}ᵢₙₜᵣₐ |
|---|---|---|---|---|---|
| cycle length | DRX cycle | [s] (number of | [s] (number of DRX | [s] (number of DRX | [s] (number of DRX |
| [s] | length [s] | 1.28 s periods) | cycles) | cycles) | cycles) |
| 5.12 ≤ | 0.32 | ≥1.28 (1) | See below (23) | 0.32 (1) | 0.64 (2) |
| eDRX_IDLE | 0.64 | ≥1.28 (1) | | 0.64 (1) | 1.28 (2) |
| cycle length | 1.28 | ≥2.56 (2) | | 1.28 (1) | 2.56 (2) |
| ≤2621.44 | 2.56 | ≥5.12 (4) | | 2.56 (1) | 5.12 (2) |

NOTE 1:
The number of DRX cycles in this table is given for the DRX cycles within PTWs.
NOTE 2:
The eDRX_IDLE cycle lengths are as specified in Section 10.5.5.32 of 3GPP Technical Specification (TS) 24.008.

T_{detect, EUTRAN_Intra} [s] (number of DRX cycles) in Table 1 is as follows:

$$eDRX\_cycle \_length \times ⌈ \frac{23}{⌈ PTW / DRX\_cycle \_length ⌉} ⌉ \qquad ( 23 )$$

### Serving Cell Measurement and Evaluation in NR

The WD may measure the SS-RSRP and SS-RSRQ level of the serving cell and evaluate the cell selection criterion S defined in 3GPP Technical Specification (TS) 38.304 v16.6.0 for the serving cell at least once every M1*N1 DRX cycle; where:
M1=2 if SMTC periodicity (T_{SMTC})>20 ms and DRX cycle≤0.64 second, otherwise M1=1.

The WD may filter the SS-RSRP and SS-RSRQ measurements of the serving cell using at least two measurements. Within the set of measurements used for the filtering, at least two measurements are spaced by, at least DRX cycle/2.

If the WD has evaluated according to Table 2 in Nₛₑᵣᵥ consecutive DRX cycles that the serving cell does not fulfil the cell selection criterion S, the WD initiates the measurements of all neighbor cells indicated by the serving cell, regardless of the measurement rules currently limiting WD measurement activities.

If the WD in RRC_IDLE has not found any new suitable cell based on searches and measurements using the intra-frequency, inter-frequency, and inter-RAT information indicated in the system information for 10 s, the WD initiates cell selection procedures for a selected Public Land Mobile Network (PLMN) as defined, for example, in 3GPP TS 38.304 v16.6.0.

TABLE 2
An example of Nₛₑᵣᵥ, i.e., number of DRX cycles.

| | |
|---|---|
| Scaling Factor (N1) | Nₛₑᵣᵥ [number |

| DRX cycle length [s] | FR1 | FR2^{Note1} | of DRX cycles] |
|---|---|---|---|
| 0.32 | 1 | 8 | M1*N1*4 |
| 0.64 | | 5 | M1*N1*4 |
| 1.28 | | 4 | N1*2 |
| 2.56 | | 3 | N1*2 |

^{Note1}
Applies for WD supporting power class 2&3&4. For WD supporting power class 1, N1 = 8 for all DRX cycle length.

Serving Cell Measurement and Evaluation in LTE eDRX

The WD measures RSRP and RSRQ levels of a serving cell and evaluates cell selection criterion S defined in 3GPP TS36.304 v16.6.0 for the serving cell at least every DRX cycle. The WD filters the RSRP and RSRQ measurements of the serving cell using at least two measurements. Within the set of measurements used for the filtering, at least two measurements are spaced by, at least DRX cycle/2.

If the WD is configured with eDRX_IDLE cycle and has evaluated according to Table 3 in Nₛₑᵣᵥ consecutive DRX cycles within a single PTW that the serving cell does not fulfil the cell selection criterion S, the WD initiates the measurements of all neighbor cells indicated by the serving cell, regardless of the measurement rules currently limiting WD measurement activities.

TABLE 3
An example of Nₛₑᵣᵥ for WD configured with eDRX_IDLE cycle.

| | | PTW | |
|---|---|---|---|
| | | length [s] | Nₛₑᵣᵥ |
| | | (number of | [number |
| | DRX cycle | 1.28 s | of DRX |
| eDRX_IDLE cycle length [s] | length [s] | periods) | cycles] |
| 5.12 ≤ eDRX_IDLE cycle | 0.32 | ≥1.28 (1) | 2 |
| length ≤ 2621.44 | 0.64 | ≥1.28 (1) | 2 |
| | 1.28 | ≥2.56 (2) | 2 |
| | 2.56 | ≥5.12 (4) | 2 |

NOTE 1:
The number of DRX cycles in this table is given for the DRX cycles within PTWs.
NOTE 2:
The eDRX_IDLE cycle lengths are as specified in Section 10.5.5.32 of 3GPP TS 24.008.

The WD initiates cell selection procedures for the selected PLMN, if the WD in RRC_IDLE has not found any new suitable cell based on searches and measurements using the intra-frequency, inter-frequency and inter-RAT information indicated in the system information for 10s. However, in FR2, it is assumed the serving cell evaluation time for WD is scaled by N1 due to Rx beam sweeping. Accordingly, the total measurement time is larger than 10s. Therefore, it is implied that the WD will always initiate cell selection procedures for the selected PLMN even if the WD hasn't finished serving cell evaluation once. However, this may result in that WD may not camp on or select a cell even though there may be a cell with good radio conditions.

In legacy LTE eDRX, T=MAX (10s, one eDRX_IDLE cycle) if the WD is configured with eDRX_IDLE cycle.

In RedCap, eDRX will be introduced for power saving. However, there is also no solution for when WD initiates cell selection procedures for a selected PLMN, if the WD, configured with eDRX in RRC_IDLE, has not found any suitable cell based on searches and measurements using the intra-frequency, inter-frequency, and inter-RAT information indicated in the system information.

### SUMMARY

Some embodiments advantageously provide methods, systems, and apparatuses for a cell selection process accounting for measurement scaling factor(s) in predetermined activity state(s) such as low activity state(s).

Some embodiments apply to a scenario where the WD is configured in DRX mode. The WD may initiate cell selection procedures for the selected PLMN, if the WD in RRC_IDLE has not found any suitable cell (e.g., new suitable cell) based on searches and measurements using the intra-frequency, inter-frequency, and/or inter-RAT information indicated in the system information, e.g., during the time T=max (10s, K1*T_{DRX}), where K1 is a scaling factor relating the DRX cycle length and RS occasion periodicity e.g., SMTC periodicity, and T_{DRX}=DRX cycle length in seconds.

Some other embodiments apply to a scenario where the WD is configured in eDRX mode. Example of eDRX cycles may be a value larger than 2.56s. When eDRX cycle=2.56s/5.12s/10.24s, there may be no PTW design.

In an embodiment, the WD may evaluate whether the WD initiates the measurements of all neighbor cells indicated by the serving cell for Nₛₑᵣᵥ consecutive eDRX cycles, regardless of the measurement rules currently limiting WD measurement activities. Example of Nₛₑᵣᵥ is 8. If no suitable cell is found, then WD may initiate cell selection procedures for the selected PLMN as defined in 3GPP TS 38.304.

TABLE 4
Another example of Nₛₑᵣᵥ for eDRX
(e.g., 2.56 s, 5.12 s and 10.24 s)

| | Scaling Factor (N1) | | Nₛₑᵣᵥ [number of |
|---|---|---|---|
| eDRX cycle length [s] | FR1 | FR2^{Note1} | eDRX cycles] |
| 2.56 | 1 | 3 | N1*2 |
| 5.12 | | 2 | N1*2 |
| 10.24 | | 2 | N1*2 |

^{Note1}
Applies for WD supporting power class 2&3&4. For WD supporting power class 1, N1 = 4 for all DRX cycle length.

If the WD is configured with an eDRX_IDLE cycle larger than 10.24s, the PTW mechanism will be applied. The design for PTW may determine (e.g., guarantee) the PTW is much smaller than eDRX cycle. In this scenario, WD may (e.g., needs to) evaluate whether the WD initiates the measurements of all neighbor cells indicated by the serving cell for Nₛₑᵣᵥ consecutive DRX cycles with in single or multiple PTWs, regardless of the measurement rules currently limiting WD measurement activities. In Frequency Range 2 (FR2), due to Rx beam sweeping, the possible Nₛₑᵣᵥ will be larger than eDRX cycle length and/or PTW.

In another embodiment, Rx beam sweeping scaling factor (N1) used is reduced for determining/deriving the Nₛₑᵣᵥ so that the number of DRX cycles in Nₛₑᵣᵥ is reduced and/or so that the evaluation time becomes shorter than PTW. Thus, the evaluation can be finished within each eDRX cycle.

In some embodiments, the evaluation time is extended to several eDRX cycles. In each eDRX cycle, part of cell evaluation may be finished, and the serving cell is considered to be suitable if evaluation has succeeded (i.e., the cell suitability criterion, also known as S-criteria, is fulfilled) such as in all eDRX cycles during evaluation.

In some other embodiments, no PTW mechanism is applied for short eDRX cycle, such as 20.48s, 40.96s. In this case, the WD may evaluate the serving cell following the eDRX cycles without assuming any PTW, and based on the evaluation may determine/decide whether to initiate measurements on neighbor cells, e.g., on carriers indicated by the serving cell.

In an embodiment, if the WD that is configured with eDRX in RRC_IDLE has not found any suitable cell based on searches and measurements using the intra-frequency, inter-frequency and inter-RAT information indicated in the system information, e.g., during the time T=max (10s, K2*TeDRX), the WD may further initiate cell selection procedures for the selected PLMN. The value of parameter K2 may be configurable and/or predefined and may also depend on the WD power class and/or frequency range (e.g., FR1, FR2, etc.), where TeDRX=eDRX cycle length, e.g., in seconds.

In other words, a clear WD measurement behavior when WD is configured with eDRX is described. The WD measurement processes described in the present disclosure provide WD power saving and/or also flexible configurations, e.g., by the network node.

According to one aspect, a network node configured to communicate with a wireless device (WD) is described. The WD is configurable to operate in a discontinuous reception mode. The network node includes processing circuitry configured to cause the WD to determine a cell selection process for a network based at least in part on whether at least one cell meets at least one cell selection condition within a time period, where the at least one cell is operated by the network node.

According to another aspect, a wireless device (WD) configured to communicate with a network node is described. The WD is configurable to operate in a discontinued reception mode and includes processing circuitry configured to perform a cell measurement associated with at least one cell associated with the network node; and determine a cell selection process for a network based at least in part on whether the at least one cell meets at least one cell selection condition within a time period.

According to one aspect, a network node configured to communicate with a wireless device (WD) using at least one cell associated with the network node is described. The WD is configurable to operate in a discontinuous reception mode. The discontinued reception mode comprises at least one of a discontinued reception cycle (DRX) and an extended discontinued reception cycle (DRX). The network node comprises processing circuitry configured to determine a configuration for the WD to operate in the discontinuous reception mode. The determined configuration is usable by the WD to perform a cell selection procedure for a network if the WD has not found at least one suitable cell based on a second measurement performed within a second time period (T2). The second time period (T2) is based at least in part on a scaling factor. The second measurement is associated with at least one second cell (Cell2) associated with the network node and is performed if the WD does not meet a cell selection criterion for a first cell (Cell1). The processing circuitry is further configured to cause transmission of the configuration to the WD.

In some embodiments, the configuration is further usable by the WD to perform a first measurement on Cell1; and evaluate whether the WD meets the cell selection criterion for Cell1 based on the first measurement performed on Cell1 within a first time period (T1).

In some other embodiments, the performing of the first measurement includes determining at least a measurement requirement is within a number of cycles (Nₛₑᵣᵥ) of the discontinued reception mode.

In an embodiment, the second time period is further based on at least one of a length of the DRX: a length of the eDRX; and a frequency range (FR).

In another embodiment, the processing circuitry is further configured to adjust the scaling factor to meet a paging time window (PTW) condition, where the PTW condition may refer to a PTW being shorter than the length of the eDRX: extend a monitoring window with multiple eDRX cycles; and extend the length of the eDRX without the PTW.

In some embodiments, the scaling factor comprises at least one of a beam sweeping factor: another factor based on a length of the DRX and a reference signal periodicity; and a power class of the WD.

In some other embodiments, the performing of the cell selection procedure includes measuring at least one other cell that is a neighbor cell to the at least one cell.

In an embodiment, the performing of the cell selection procedure includes at least one of scanning at least a communication channel in a frequency band to determine whether the at least one suitable cell has been found based on at least the second measurement, the at least one suitable cell meeting at least one cell selection condition.

In another embodiment, the performing of the cell selection procedure for the network includes determining that the at least one cell is not the at least one suitable cell based at least in part on a cell search and the second measurement.

In some embodiments, the configuration includes at least one rule for the WD to determine at least the second time period.

In some other embodiments, at least one of the first cell (Cell1) is a serving cell: the at least one second cell (Cell2) is a neighbor cell: the network is a Public Land Mobile Network (PLMN); and the WD is a reduced capability (RedCap) device.

According to another aspect, a method in a network node configured to communicate with a wireless device (WD) using at least one cell associated with the network node is described. The WD is configurable to operate in a discontinuous reception mode comprising at least one of a discontinued reception cycle (DRX) and an extended discontinued reception cycle (DRX). The method comprises determining a configuration for the WD to operate in the discontinuous reception mode. The determined configuration is usable by the WD to perform a cell selection procedure for a network if the WD has not found at least one suitable cell based on a second measurement performed within a second time period (T2). The second time period (T2) is based at least in part on a scaling factor. The second measurement is associated with at least one second cell (Cell2) associated with the network node and is performed if the WD does not meet a cell selection criterion for a first cell (Cell1). The method further includes transmitting the configuration to the WD.

In some embodiments, the configuration is further usable by the WD to perform a first measurement on Cell1; and evaluate whether the WD meets the cell selection criterion for Cell1 based on the first measurement performed on Cell1 within a first time period (T1).

In some other embodiments, the performing of the first measurement includes determining at least a measurement requirement is within a number of cycles (Nₛₑᵣᵥ) of the discontinued reception mode.

In an embodiment, the time second period is further based on at least one of a length of the DRX; a length of the eDRX; and a frequency range (FR).

In another embodiment, the method further includes adjusting the scaling factor to meet a paging time window (PTW) condition, where the PTW condition is a PTW is shorter than the length of the eDRX: extending a monitoring window with multiple eDRX cycles; and extending the length of the eDRX without the PTW.

In some embodiments, the scaling factor comprises at least one of a beam sweeping factor: another factor based on a length of the DRX and a reference signal periodicity; and a power class of the WD.

In some other embodiments, the performing of the cell selection procedure includes measuring at least one other cell that is a neighbor cell to the at least one cell.

In an embodiment, the performing of the cell selection procedure includes scanning at least a communication channel in a frequency band to determine whether the at least one suitable cell has been found based on at least the second measurement. The at least one suitable cell meeting at least one cell selection condition.

In another embodiment, the performing of the cell selection procedure for the network includes determining that the at least one cell is not the at least one suitable cell based at least in part on a cell search and the second measurement.

In some embodiments, the configuration includes at least one rule for the WD to determine at least the second time period.

In some other embodiments, at least one of the first cell (Cell1) is a serving cell: the at least one second cell (Cell2) is a neighbor cell: the network is a Public Land Mobile Network (PLMN); and the WD is a reduced capability (RedCap) device.

According to one aspect, a wireless device (WD) configured to communicate with a network node is described. The WD is configurable to operate in a discontinued reception mode comprising at least one of a discontinued reception cycle (DRX) and an extended discontinued reception cycle (DRX). The WD comprises processing circuitry configured to perform a second measurement associated with at least one second cell (Cell2) associated with the network node if the WD does not meet a cell selection criterion for a first cell (Cell1); and perform a cell selection procedure for a network if the WD has not found at least one suitable cell based on the performed second measurement within a second time period (T2), where the second time period (T2) is based at least in part on a scaling factor.

In some embodiments, the processing circuitry is further configured to perform a first measurement on Cell1; and evaluate whether the WD meets the cell selection criterion for Cell1 based on the first measurement performed on Cell1 within a first time period (T1).

In some other embodiments, the performing of the first measurement on Cell 1 includes determining at least a measurement requirement is within a number of cycles (Nₛₑᵣᵥ) of the discontinued reception mode.

In an embodiment, the second time period is further based on at least one of a length of the DRX: a length of the eDRX; and a frequency range (FR).

In another embodiment, the processing circuitry is further configured to adjust the scaling factor to meet a paging time window (PTW) which is a PTW is shorter than the length of the eDRX: extend a monitoring window with multiple eDRX cycles; and extend the length of the eDRX without the PTW.

In some embodiments, the scaling factor comprises at least one of a beam sweeping factor; another factor based on a length of the DRX and a reference signal periodicity; and a power class of the WD.

In some other embodiments, the performing of the cell selection procedure includes measuring at least one other cell that is a neighbor cell to the at least one cell.

In an embodiment, the performing of the cell selection procedure includes scanning at least a communication channel in a frequency band to determine whether the at least one suitable cell has been found based on at least the performed second measurement, the at least one suitable cell meeting at least one cell selection condition.

In another embodiment, the performing of the cell selection procedure for the network includes determining that the at least one cell is not the at least one suitable cell based at least in part on a cell search and the second measurement.

In some embodiments, the processing circuitry is further configured to at least one of perform the second measurement and perform the cell selection procedure based on a configuration received from the network node.

In some other embodiments, at least one of the first cell (Cell1) is a serving cell: the at least one second cell (Cell2) is a neighbor cell; the network is a Public Land Mobile Network (PLMN); and the WD is a reduced capability (RedCap) device.

According to one aspect, a method in a wireless device (WD) configured to communicate with a network node. The WD is configurable to operate in a discontinued reception mode comprising at least one of a discontinued reception cycle (DRX) and an extended discontinued reception cycle (DRX). The method comprises performing a second measurement associated with at least one second cell (Cell2) associated with the network node if the WD does not meet a cell selection criterion for a first cell (Cell1); and performing a cell selection procedure for a network if the WD has not found at least one suitable cell based on the performed second measurement within a second time period (T2) which is based at least in part on a scaling factor.

In some embodiments, the method further comprises performing a first measurement on Cell1; and evaluating whether the WD meets the cell selection criterion for Cell1 based on the first measurement performed on Cell1 within a first time period (T1).

In some other embodiments, the performing of the first measurement on Cell1 includes determining at least a measurement requirement is within a number of cycles (Nₛₑᵣᵥ) of the discontinued reception mode.

In some other embodiments, the second time period is further based on at least one of a length of the DRX; a length of the eDRX; and a frequency range (FR).

In an embodiment, the method further includes adjusting the scaling factor to meet a paging time window (PTW) condition, where the PTW condition is a PTW is shorter than the length of the eDRX: extending a monitoring window with multiple eDRX cycles; and extending the length of the eDRX without the PTW.

In another embodiment, the scaling factor comprises at least one of a beam sweeping factor; another factor based on a length of the DRX and a reference signal periodicity; and a power class of the WD.

In some embodiments, the performing of the cell selection procedure includes measuring at least one other cell that is a neighbor cell to the at least one cell.

In some other embodiments, the performing of the cell selection procedure includes scanning at least a communication channel in a frequency band to determine whether the at least one suitable cell has been found based on at least the performed second measurement, the at least one suitable cell meeting at least one cell selection condition.

In an embodiment, the performing of the cell selection procedure for the network includes determining that the at least one cell is not the at least one suitable cell based at least in part on a cell search and the second measurement.

In another embodiment, the method further includes at least one of performing the second measurement and performing the cell selection procedure based on a configuration received from the network node.

In some embodiments, at least one of the first cell (Cell1) is a serving cell: the at least one second cell (Cell2) is a neighbor cell: the network is a Public Land Mobile Network (PLMN); and the WD is a reduced capability (RedCap) device.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows a typical H-SFN cycle;

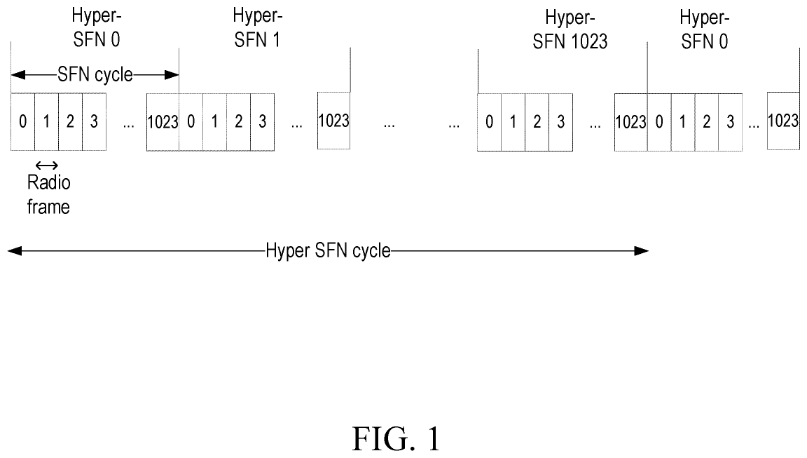

FIG. 2 shows a typical relation between H-SFN, PTW, and eDRX periodicity:

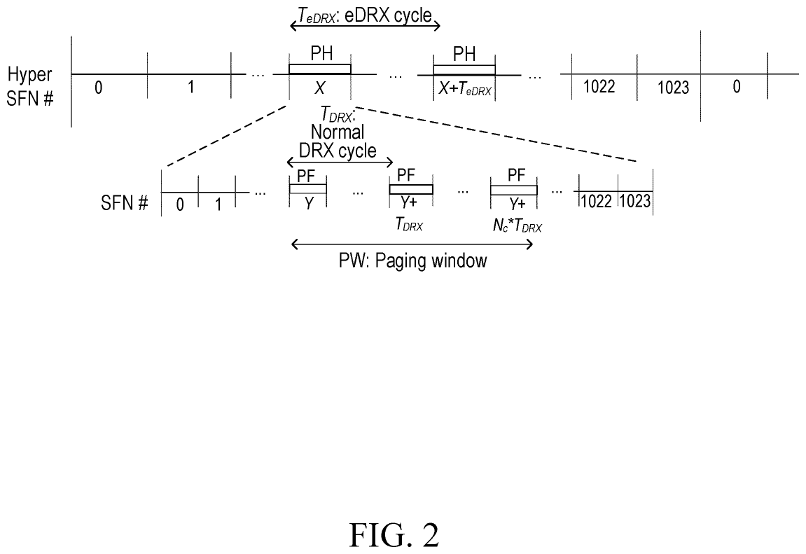

FIG. 3 is a schematic diagram of an example network architecture illustrating a communication system according to principles disclosed herein;

FIG. 4 is a block diagram of a network node in communication with a wireless device over a wireless connection according to some embodiments of the present disclosure:

FIG. 5 is a flowchart of an example process in a network node for causing a WD to determine a cell selection process according to some embodiments of the present disclosure:

FIG. 6 is a flowchart of an example process in a wireless device for determining a cell selection process according to some embodiments of the present disclosure;

FIG. 7 is a flowchart of another example process in a network node for causing a WD to determine a cell selection process according to some embodiments of the present disclosure; and

FIG. 8 is a flowchart of another example process in a wireless device for determining a cell selection process according to some embodiments of the present disclosure.

### DETAILED DESCRIPTION

Before describing in detail example embodiments, it is noted that the embodiments reside primarily in combinations of apparatus components and processing steps related to a cell selection process accounting for measurement scaling factor(s) in predetermined activity state(s) such as low activity state(s). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected.” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of radio base station, base transceiver station (BTS), base station controller (BSC), radio network controller (RNC), g Node B (gNB), evolved Node B (eNB or eNodeB), Master eNB (MeNB), Slave (SeNB), location measurement unit (LMU), integrated access backhaul (IAB) node, Central Unit (e.g. in a gNB), Distributed Unit (e.g. in a gNB), Baseband Unit, Centralized Baseband, C-RAN, network controller, radio network controller (RNC). Operation and Maintenance (O&M), Operation Support Systems (OSS), Node B, multi-standard radio (MSR) radio node such as MSR BS, multi-cell/multicast coordination entity (MCE), relay node, donor node controlling relay, radio access point (AP), transmission points, transmission nodes, transmission reception point (TRP), Remote Radio Unit (RRU) Remote Radio Head (RRH), a core network node (e.g., mobile management entity (MME), self-organizing network (SON) node, a coordinating node, positioning node such as E-SMLC, MDT node, MSC, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node. The term “node” may refer to a network node and/or WD (or a user equipment (UE)).

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, vehicular to vehicular (V2V), machine type WD or WD capable of machine to machine communication (M2M), low-cost and/or low-complexity WD, a sensor equipped with WD, Personal Digital Assistant (PDA), Tablet, mobile terminals, smart phone, laptop embedded equipped (LEE), laptop mounted equipment (LME), USB dongles, Customer Premises Equipment (CPE), an Internet of Things (IoT) device, or a Narrow band IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

The term radio access technology (RAT), may refer to any RAT, e.g., UTRA, E-UTRA, narrow band internet of things (NB-IoT), WiFi, Bluetooth, next generation RAT, New Radio (NR). 4G, 5G, etc. Any of the equipment denoted by the term node, network node or radio network node may be capable of supporting a single or multiple RATs.

The term signal or radio signal used herein can be any physical signal or physical channel. Examples of downlink (DL) physical signals are reference signal (RS) such as PSS, SSS, CSI-RS, Demodulation Reference Signal (DMRS) signals in SS/PBCH block (SSB), discovery reference signal (DRS), Cell specific Reference Signal (CRS), Positioning Reference Signal (PRS). RS may be periodic e.g., RS occasion carrying one or more RSs may occur with certain periodicity e.g., 20 ms, 40 ms, etc. The RS may also be aperiodic. Each SSB may carry NR-PSS, NR-SSS and NR-PBCH in four successive symbols. One or multiple SSBs may be transmitted in one SSB burst which is repeated with certain periodicity, e.g., 5 ms, 10 ms, 20 ms, 40 ms, 80 ms and 160 ms.

The WD may be configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g., serving cell system frame number (SFN)). SMTC occasion(s) may also occur with certain periodicity e.g., 5 ms, 10 ms, 20 ms, 40 ms, 80 ms and 160 ms. Examples of uplink (UL) physical signals are reference signal such as SRS, DMRS etc. The term physical channel may refer to any channel carrying higher layer information, e.g., data, control. Examples of physical channels are PBCH, Narrow Band Physical Broadcast Channel (NPBCH), Physical Downlink Control Channel (PDCCH), Physical Downlink Shared Channel (PDSCH), Short Physical Uplink Control Channel (sPUCCH), Short Physical Downlink Shared Channel (sPDSCH), Short Physical Uplink Control Channel (sPUCCH), Short Physical Uplink Shared Channel (sPUSCH), Machine-Type-Communications Physical Downlink Control Channel (MPDCCH), Narrow Band Physical Downlink Control Channel (NPDCCH), Narrow Band Physical Downlink Shared Channel (NPDSCH), Enhanced Physical Downlink Control Channel (E-PDCCH), Physical Uplink Shared Channel (PUSCH), Physical Uplink Control Channel (PUCCH), Narrow Band Physical Uplink Shared Channel (NPUSCH), etc.

In some embodiments, the term “serving cell” may refer to any cell such as a cell serving a WD, e.g., a primary cell, a secondary cell, etc. For example, for a WD not configured with carrier aggregation, the serving cell may be a primary cell. For a WD configured with carrier aggregation, the serving cell may comprise a set of one or more cells comprising of the primary cell and all secondary cells. In a nonlimiting example, a primary cell may be a cell, operating on the primary frequency, e.g., in which the WD either performs an initial connection establishment procedure and/or initiates the connection re-establishment procedure, and/or the cell indicated as the primary cell in a handover procedure. In another nonlimiting example, a secondary cell may be cell, operating on a secondary frequency, e.g., which may be configured once a connection is established and which may be used to provide additional radio resources.

In some other embodiments, the term “neighbor cell” may refer to any cell such as cell usable by the WD to communicate with a network node. The neighbor cell may be indicated to the WD by the network node. A neighbor cell may have characteristics that are different from/similar to another cell such as a serving cell. In a nonlimiting example, a neighbor cell may operate in a predetermined frequency which may be the same as or different from a serving cell. The predetermined frequency may partially overlap (or not overlap) with the frequency of a serving cell. A neighbor cell may be operated by the same network node as a serving cell or a different network node. Further, a neighbor cell may be located within a predetermined distance of a serving cell.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to performing measurements on one or more serving cell(s) and/or one or more neighbor cells and/or neighbor frequencies. e.g., on a serving carrier and/or one or more additional carriers configured for measurements.

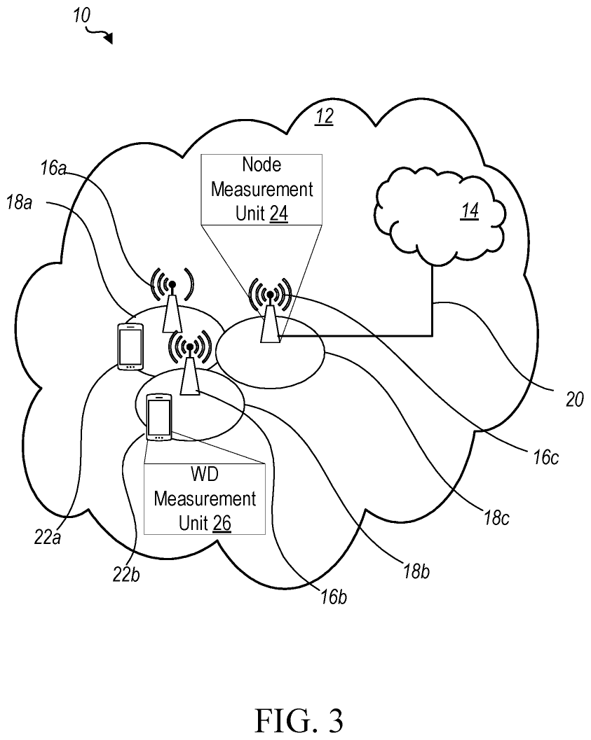

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a. 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE and/or Enhanced UMTS (Universal Mobile Telecommunications System) Terrestrial Radio Access Network (E-UTRAN) and a gNB for NR/NG-RAN.

A network node 16 (eNB or gNB) is configured to include a node measurement unit 24 which is configured to cause the WD 22 to determine a cell selection process. A wireless device 22 is configured to include a WD measurement unit 26 which is configured to determine a cell selection process.

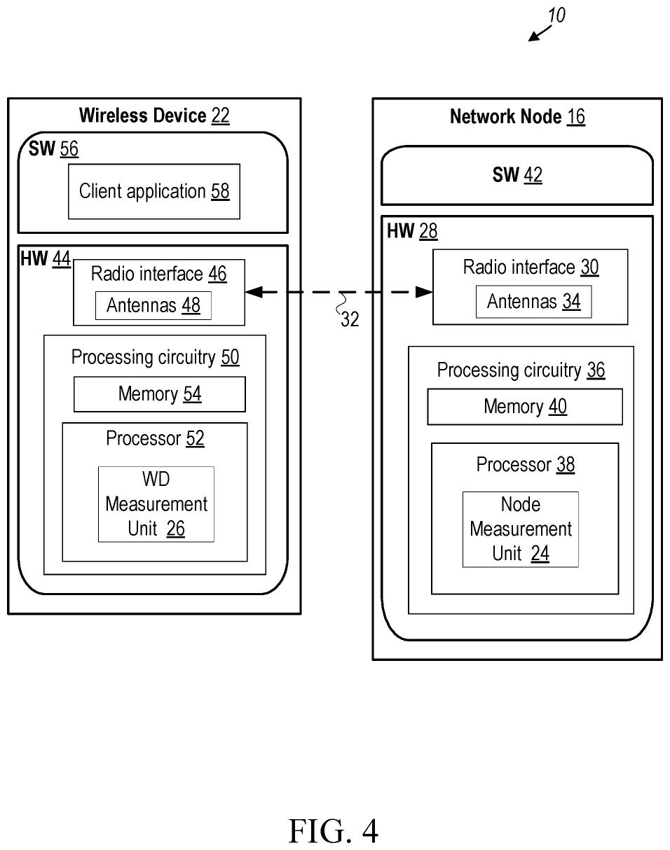

Example implementations, in accordance with an embodiment, of the WD 22 and network node 16 discussed in the preceding paragraphs will now be described with reference to FIG. 4.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include node measurement unit 24 which is configured to cause the WD 22 to determine a cell selection process.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include WD measurement unit 26 which is configured to determine a cell selection process.

In some embodiments, the inner workings of the network node 16 and WD 22 may be as shown in FIG. 4 and independently, the surrounding network topology may be that of FIG. 3.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 3 and 4 show various “units” such as node measurement unit 24 and WD measurement unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

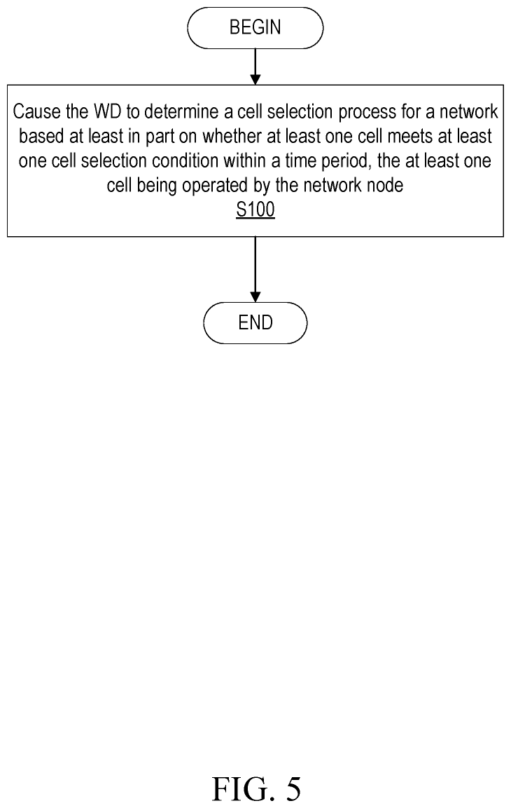

FIG. 5 is a flowchart of an example process in a network node 16 for causing the WD 22 to determine a cell selection process. One or more blocks described herein may be performed by one or more elements of network node 16 such as by one or more of processing circuitry 36 (including the node measurement unit 24), processor 38, and/or radio interface 30. Network node 16 such as via processing circuitry 36 and/or processor 38 and/or radio interface 30 is configured to cause (Block S100) the WD 22 to determine a cell selection process for a network based at least in part on whether at least one cell meets at least one cell selection condition within a time period. The at least one cell is operated by the network node 16.

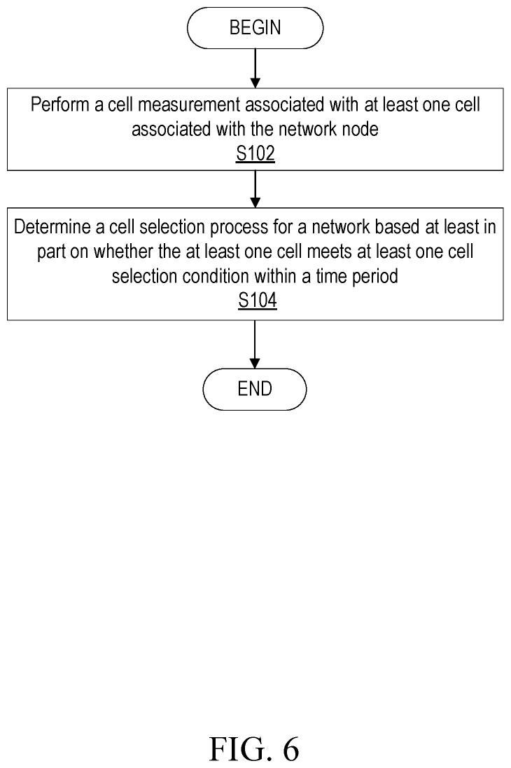

FIG. 6 is a flowchart of an example process in a wireless device 22 for determining a cell selection process according to some embodiments of the present disclosure. One or more blocks described herein may be performed by one or more elements of wireless device 22 such as by one or more of processing circuitry 50 (including the WD measurement unit 26), processor 52, and/or radio interface 46. Wireless device 22 such as via processing circuitry 50 and/or processor 52 and/or radio interface 46 is configured to perform (Block S102) a cell measurement associated with at least one cell associated with the network node 16; and determine (Block S104) a cell selection process for a network based at least in part on whether the at least one cell meets at least one cell selection condition within a time period

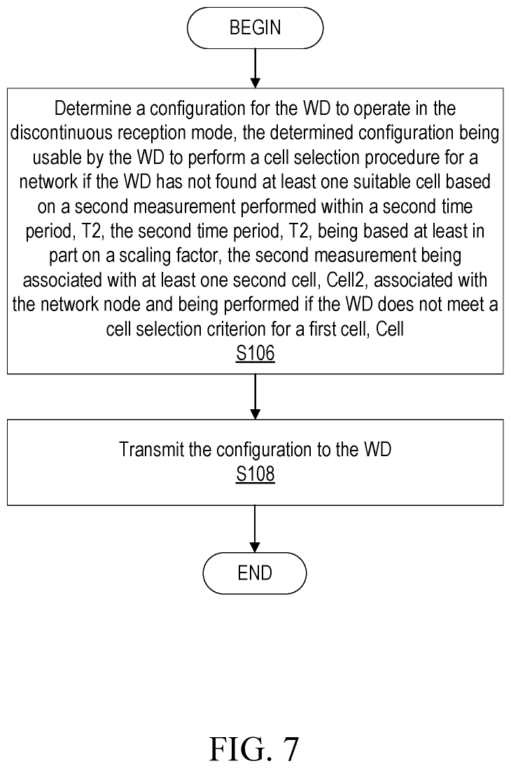

FIG. 7 is a flowchart of an example process in a network node 16 for causing the WD 22 to determine a cell selection process. One or more blocks described herein may be performed by one or more elements of network node 16 such as by one or more of processing circuitry 36 (including the node measurement unit 24), processor 38, and/or radio interface 30. Network node 16 is configured to determine (Block S106) a configuration for the WD 22 to operate in the discontinuous reception mode. The determined configuration is usable by the WD 22 to perform a cell selection procedure for a network if the WD 22 has not found at least one suitable cell based on a second measurement performed within a second time period (T2). The second time period (T2) is based at least in part on a scaling factor. The second measurement is associated with at least one second cell (Cell2) associated with the network node and is performed if the WD 22 does not meet a cell selection criterion for a first cell (Cell1). Network node 16 may be further configured to transmit (Block S108) the configuration to the WD 22.

In some embodiments, the configuration is further usable by the WD 22 to perform a first measurement on Cell1; and evaluate whether the WD 22 meets the cell selection criterion for Cell1 based on the first measurement performed on Cell1 within a first time period (T1).

In some other embodiments, the performing of the first measurement includes determining at least a measurement requirement is within a number of cycles (Nserv) of the discontinued reception mode.

In an embodiment, the time second period is further based on at least one of a length of the DRX: a length of the eDRX; and a frequency range (FR).

In another embodiment, the method further includes adjusting the scaling factor to meet a paging time window (PTW) condition, where the PTW condition is a PTW is shorter than the length of the eDRX: extending a monitoring window with multiple eDRX cycles; and extending the length of the eDRX without the PTW.

In some embodiments, the scaling factor comprises at least one of a beam sweeping factor; another factor based on a length of the DRX and a reference signal periodicity; and a power class of the WD 22.

In some other embodiments, the performing of the cell selection procedure includes measuring at least one other cell that is a neighbor cell to the at least one cell.

In an embodiment, the performing of the cell selection procedure includes scanning at least a communication channel in a frequency band to determine whether the at least one suitable cell has been found based on at least the second measurement. The at least one suitable cell meeting at least one cell selection condition.

In another embodiment, the performing of the cell selection procedure for the network includes determining that the at least one cell is not the at least one suitable cell based at least in part on a cell search and the second measurement.

In some embodiments, the configuration includes at least one rule for the WD 22 to determine at least the second time period.

In some other embodiments, at least one of the first cell (Cell1) is a serving cell: the at least one second cell (Cell2) is a neighbor cell; the network is a Public Land Mobile Network (PLMN); and the WD 22 is a reduced capability (RedCap) device.

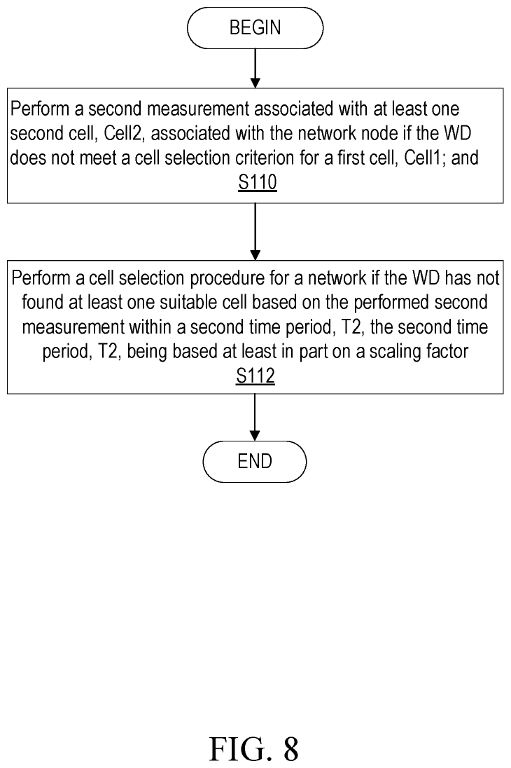

FIG. 8 is a flowchart of an example process in a wireless device 22 for determining a cell selection process according to some embodiments of the present disclosure. One or more blocks described herein may be performed by one or more elements of wireless device 22 such as by one or more of processing circuitry 50 (including the WD measurement unit 26), processor 52, and/or radio interface 46. Wireless device 22 is configured to perform (Block S110) a second measurement associated with at least one second cell (Cell2) associated with the network node if the WD does not meet a cell selection criterion for a first cell (Cell1); and perform (Block S112) a cell selection procedure for a network if the WD has not found at least one suitable cell based on the performed second measurement within a second time period (T2) which is based at least in part on a scaling factor.

In some embodiments, the method further comprises performing a first measurement on Cell1; and evaluating whether the WD 22 meets the cell selection criterion for Cell1 based on the first measurement performed on Cell1 within a first time period (T1).

In some other embodiments, the performing of the first measurement on Cell1 includes determining at least a measurement requirement is within a number of cycles (Nserv) of the discontinued reception mode.

In some other embodiments, the second time period is further based on at least one of a length of the DRX; a length of the eDRX; and a frequency range (FR).

In an embodiment, the method further includes adjusting the scaling factor to meet a paging time window (PTW) condition, where the PTW condition is a PTW is shorter than the length of the eDRX; extending a monitoring window with multiple eDRX cycles (e.g., Option 2: the cell evaluation time can be finished during several eDRX cycles); and extending the length of the eDRX without the PTW.

In another embodiment, the scaling factor comprises at least one of a beam sweeping factor: another factor based on a length of the DRX and a reference signal periodicity; and a power class of the WD 22.

In some embodiments, the performing of the cell selection procedure includes measuring at least one other cell that is a neighbor cell to the at least one cell.

In some other embodiments, the performing of the cell selection procedure includes scanning at least a communication channel in a frequency band to determine whether the at least one suitable cell has been found based on at least the performed second measurement, the at least one suitable cell meeting at least one cell selection condition.

In an embodiment, the performing of the cell selection procedure for the network includes determining that the at least one cell is not the at least one suitable cell based at least in part on a cell search and the second measurement.

In another embodiment, the method further includes at least one of performing the second measurement and performing the cell selection procedure based on a configuration received from the network node.

In some embodiments, at least one of the first cell (Cell1) is a serving cell: the at least one second cell (Cell2) is a neighbor cell: the network is a Public Land Mobile Network (PLMN); and the WD 22 is a reduced capability (RedCap) device.

Having described the general process flow of arrangements of the disclosure and having provided examples of hardware and software arrangements for implementing the processes and functions of the disclosure, the sections below provide details and examples of arrangements for a cell selection process accounting for measurement scaling factor(s) in predetermined activity state(s) such as low activity state(s). In some embodiments, a cell selection process is determined for a network, e.g., PLMN, based at least in part on whether at least one cell meets at least one cell selection condition, e.g., WD 22 has not found any cell such as a new suitable cell based on searches and/or measurements, within a time period, e.g., T. A cell selection condition may be any condition for selecting a cell for transmitting/receiving signals in the cell, such as conditions/parameters in Tables 5-11 of the present disclosure. Any other source of conditions may be used.

### Example Scenario

In an embodiment, a scenario comprises at least one WD 22 which is operating in a first cell (e.g., cell1) served by a network node 16 (e.g., a first network node), and/or performing measurements on one or more serving cell(s) and/or one or more neighbor cells and/or neighbor frequencies, e.g., on serving carrier and/or one or more additional carriers configured for measurements. WD 22 may be configurable/configured to operate in a discontinuous reception mode, e.g., DRX, eDRX, and/or any other discontinuous mode. Any carrier (e.g., additional carrier) may belong to a RAT of the serving carrier frequency. In this case, if the carrier is non-serving carrier then the carrier may be referred to as inter-frequency carrier. The additional carrier may also belong to another RAT and may be referred to as inter-RAT carrier. The term carrier may also interchangeably be referred to as carrier frequency, layer, frequency layer, carrier frequency layer, etc. For ease of understanding and/or consistency the term carrier is used herein after.

The WD 22 may be configured to stay in IDLE mode and/or inactive mode with an eDRX cycle. The WD 22 may perform measurements for cell reselection to meet the measurement requirements associated with that eDRX.

Some embodiments are applicable for a WD 22 configured in and/or operating in any low activity RRC state. Examples of low activity RRC state are RRC idle state, RRC inactive state, etc. In the low activity RRC state, the WD 22 may be configured with DRX cycle or in both, DRX cycle and eDRX cycle. In the low activity RRC state, the WD 22 may be configured with DRX cycle equal to or larger than certain DRX threshold (e.g., Hdrx). A nonlimiting example of Hdrx is 0.32 seconds.

### Methods in the WD 22 for Performing Serving Cell Measurements in Normal DRX Cycle

The embodiments described herein may also be implemented in any combination. The WD 22 embodiment may include at least (or any one of) the following:
Step 1: WD 22 performs serving cell measurement and/or evaluates measurement requirements within Nₛₑᵣᵥ number of DRX cycles; and/or
Step 2: WD 22 performs one or more cell selection procedures for the selected PLMN if WD 22 has not found any cell (e.g., new suitable cell) based on searches and/or measurements within a time period, e.g., T.

Before performing the one or more cell selection procedures, the WD 22 may further determine the time period, T, based on a rule, which may be pre-defined and/or configured by a network node 16 and/or autonomously determined by the WD 22.

### Step 1

In this step, the WD 22 performs normal serving cell measurements based at least in part on SS-RSRP and/and SS-RSRQ measurements. The detail Nserv time (i.e., Nₛₑᵣᵥ time) in FR2 may be transformed from the Table 2 to Table 5. If the WD 22 has determined/evaluated according to Table 5 in Nₛₑᵣᵥ consecutive DRX cycles that the serving cell does not fulfil the cell selection criterion S, the WD 22 may initiate the measurements of cells, e.g., all neighbor cells, indicated by the serving cell, regardless of the measurement rules currently limiting WD 22 measurement activities/processes.

TABLE 5
An example of Nserv in FR2.

| | FR2 PC1 | | FR2 PC 2&3&4 | |
|---|---|---|---|---|
| DRX cycle | Nₛₑᵣᵥ [number | | Nₛₑᵣᵥ [number | |
| length [s] | of DRX cycles] | Tₛₑᵣᵥ(s) | of DRX cycles] | Tₛₑᵣᵥ(s) |
| 0.32 | 32*M1 | 20.48(M1 = 2), 10.24(M1 = 1) | 32*M1 | 20.48(M1 = 2), 10.24(M1 = 1) |
| 0.64 | 32*M1 | 40.96(M1 = 2), 20.48(M1 = 1) | 20*M1 | 25.6(M1 = 2), 12.8(M1 = 1) |
| 1.28 | 16 | 20.48 | 8 | 10.24 |
| 2.56 | 16 | 40.96 | 6 | 15.36 |

In one example, the WD 22 is in FR2 for supporting PC3 with DRX=2.56s, the WD 22 will initiate the measurements of all neighbor cells after 6*DRX cycles (15.36s). This ensures that the WD 22 does not trigger cell selection procedure for the selected PLMN before the serving cell evaluation is completed. In this case T which is used for deciding whether to initiate cell selection procedure on the selected PLMN can be expressed as function of fixed value=α time units or time resources, scaling factor=K1 and DRX cycle length=T_{DRX} as follows:

$$T = f ( α , K 1 , {T}_{DRX} )$$

Examples of a function are maximum, minimum, product, sum, ceil, floor, ratio, xth percentile, combination of one or more functions.

An example of T, assuming α=10 s, is given below:

$$T = max ( 10 s , K 1 * {T}_{DRX} ) ,$$

K1 values are derived based on the table 5. e.g., K1=6 for DRX cycle length (T_{DRX})=0.32 s or 0.64 s and 3 for DRX cycle length (T_{DRX})=1.28 s or 2.56 s. K1 may be different for FR1 and FR2.

In another example, the WD 22 is in FR2 for supporting PCI with DRX cycle length (T_{DRX})=2.56s, the WD 22 will initiate the measurements of all neighbor cells after 16*T_{DRX}=40.96s.

In yet another example, the value of K1 can be in the formula used for deriving T can be derived based on one or more of following:
configured by network node 16 such as a gNB,
predefined (e.g., in specification)
based on WD power class
based on operating frequency range (e.g., FR1, FR2, . . . ) based on type of type of spectrum access (e.g. licensed carrier or unlicensed carrier)

### Step 2

In this step, the WD 22 performs one or more cell selection procedures for the selected PLMN if the WD 22 has not found any new suitable cell based on searches and measurements within time period, T.

Examples of cell selection procedures for the selected PLMN are:
WD 22 scans all RF channels in the NR bands according to its capabilities to find or detect a suitable cell; and/or
WD 22 uses stored information of frequencies and may also use information associated with cell parameters from previously received measurement control information elements and/or from previously detected cells for selecting a cell.

The time T is expressed by a general function as follows:

$$T = f 1 ( β , K , {T}_{DRX} )$$

Examples of functions may include maximum, average, sum, product, minimum, ceil, floor, etc., and any combinations of such functions.

In one example assume β=10 seconds and K=M1*N1*K1, the T can be expressed by the following function:

$$T = max ( 10 s , M 1 * N 1 * K 1 * {T}_{DRX} )$$

where, M1=2 if SMTC periodicity (T_{SMTC})>20 ms and DRX cycle length (T_{DRX})≤0.64 second, otherwise M1=1. N1=1 for FR1 serving cell. In FR2, for WD support power class 2&3&4, N1=8 for T_{DRX}=0.32s, 5 for T_{DRX}=0.64s, 4 for T_{DRX}=1.28s and 3 for T_{DRX}=2.56s. In FR2, for WD support power class 1, N1=8. K1=6 for T_{DRX}=0.32, 0.64s and 3 for T_{DRX}=1.28, 2.56s.

In another example, T=max (10s, (M1*N1*K2*T_{DRX}+J2*T_{DRX})) where, M1=2 if SMTC periodicity (T_{SMTC})>20 ms and DRX cycle≤0.64 second, otherwise M1=1. N1=1 for FR1 serving cell. In FR2, for WD support power class 2&3&4, N1=8 for T_{DRX}=0.32s, 5 for T_{DRX}=0.64s, 4 for T_{DRX}=1.28s and 3 for DRX=2.56s. In FR2, for WD support power class 1, N1=8. K1=4 for T_{DRX}=0.32, 0.64s and 2 for T_{DRX}=1.28, 2.56s. J2=2.

Methods in the WD 22 for Performing Serving Cell Measurements in eDRX

The embodiments described herein may also be implemented in any combination. The WD 22 embodiment comprises at least the following:
Step 1: WD 22 performs serving cell measurement and evaluates measurement requirements within Nₛₑᵣᵥ number of eDRX cycles
Step 2: WD 22 performs one or more cell selection procedures for the selected PLMN if the WD 22 has not found any new suitable cell based on searches and measurements within the time period, T

Before performing the one or more cell selection procedures the WD 22 may further determine the time period, T, based on a rule, which may be pre-defined or configured by a network node 16 or autonomously determined by the WD 22.

### Step 1:

In this step, the WD 22 performs normal serving cell measurements based on SS-RSRP and SS-RSRQ measurements.

The detail Nₛₑᵣᵥ time can be updated based on LTE eDRX as follow.

Scenario 1: eDRX_IDLE Cycle Smaller or Equal to 10.24s

If the WD 22 is configured with eDRX_IDLE cycle smaller or equal to 10.24s and has evaluated Nₛₑᵣᵥ number of consecutive eDRX cycles that the serving cell does not fulfil the cell selection criterion S, the WD 22 shall initiate the measurements of all neighbor cells indicated by the serving cell, regardless of the measurement rules currently limiting WD measurement activities.

TABLE 6
An example of Nₛₑᵣᵥ for eDRX (e.g., 2.56 s, 5.12 s and 10.24 s)

| | Scaling Factor (N1) | | Nₛₑᵣᵥ [number of |
|---|---|---|---|
| eDRX cycle length [s] | FR1 | FR2^{Note1} | eDRX cycles] |
| 2.56 | | 3 | N1*2 |
| 5.12 | 1 | 2 | N1*2 |
| 10.24 | | 2 | N1*2 |

^{Note1}
Applies for WD supporting power class 2&3&4. For WD supporting power class 1, N1 = 4 for all DRX cycle length.

Scenario 2: eDRX_IDLE Cycle Larger than 10.24s

If the WD 22 is configured with eDRX_IDLE cycle larger than 10.24s and has evaluated Nₛₑᵣᵥ consecutive number of DRX cycles within a single PTW that the serving cell does not fulfil the cell selection criterion S, the WD 22 shall initiate the measurements of all neighbor cells indicated by the serving cell, regardless of the measurement rules currently limiting WD measurement activities.

### Option 1: Limiting the Rx Beam Scaling Factor

In one embodiment, the Rx beam scaling factor can be determined (e.g., limited) to such that (e.g., to guarantee) the length of PTW can be shorter than eDRX cycle. The evaluation time Nₛₑᵣᵥ can be still in one eDRX cycle. The New can be defined as follows.

TABLE 7
Another example of Nₛₑᵣᵥ for eDRX (e.g., larger than 10.24 s)

| | | PTW | |
|---|---|---|---|
| | | length [s] | Nₛₑᵣᵥ [s] |
| | | (number of | (number |
| | DRX cycle | 1.28 s | of DRX |
| eDRX_IDLE cycle length [s] | length [s] | periods) | cycles) ^{Note3} |
| 20.48 ≤ eDRX_IDLE cycle | 0.32 | ≥1.28 (1) | M3*N3*2 |
| length ≤ 2621.44 | 0.64 | ≥2.56 (2) | M3*N3*2 |
| | 1.28 | ≥5.12 (4) | N3*2 |
| | 2.56 | ≥10.24 (8) | N3*2 |

NOTE 1:
The number of DRX cycles in this table is given for the DRX cycles within PTWs.
NOTE 2:
The eDRX_IDLE cycle lengths are as specified in Section 10.5.5.32 of TS 24.008.
^{NOTE3}
In FR1, N3 = 1. In FR2, N3 = 2.

In one nonlimiting example,

M3=2 if SMTC periodicity (T_{SMTC})>20 ms and DRX cycle length (T_{DRX})≤0.64 second, otherwise M3=1, e.g., in another nonlimiting example.

Option 2; Extend the Monitoring eDRX Window

In another embodiment, the cell evaluation time can be finished during several eDRX cycles.

The Nₛₑᵣᵥ can be defined as follow.

TABLE 8
Another example of Nserv for eDRX (e.g., larger than 10.24s)
In an example, M3 = 2 if SMTC periodicity (T_{SMTC}) > 20 ms and DRX cycle length
(T_{DRX}) ≤ 0.64 second, otherwise M3 = 1. In another example, M3 = 1.

| | | PTW length [s] | Nₛₑᵣᵥ [s] |
|---|---|---|---|
| | DRX cycle | (number of 1.28s | (number of |
| eDRX_IDLE cycle length [s] | length [s] | periods) | DRX cycles)^{Note3} |
| 20.48 ≤ eDRX_IDLE cycle length ≤ 2621.44 | 0.32 | ≥1.28 (1) | $eDRX * ⌈ \frac{M 3 * N 3 * 2}{PTW / DRX} ⌉ ( M 3 * N 3 * 2 )$ |
| | 0.64 | ≥1.28 (1) | $eDRX * ⌈ \frac{M 3 * N 3 * 2}{PTW / DRX} ⌉ ( M 3 * N 3 * 2 )$ |
| | 1.28 | ≥2.56 (2) | $eDRX * ⌈ \frac{N 3 * 2}{PTW / DRX} ⌉ ( N 3 * 2 )$ |
| | 2.56 | ≥5.12 (4) | $eDRX * ⌈ \frac{N 3 * 2}{PTW / DRX} ⌉ ( N 3 * 2 )$ |

NOTE 1:
The number of DRX cycles in this table is given for the DRX cycles within PTWs.
NOTE 2:
The eDRX_IDLE cycle lengths are as specified in Section 10.5.5.32 of TS 24.008.
NOTE 3:
In FR1, N3 = 1. In FR2, for WD supporting power class 2 & 3 & 4, N3 = 2. In FR2, for WD supporting power class 1, N3 = 4.

Option 3: Extend the &DRX Cycle without PTW

In another embodiment, the eDRX with PTW mechanism can be applied only for DRX length (Te_{DRX})>40.96s. The eDRX cycle without PTW will be applied if eDRX cycle length (Te_{DRX})<40.968.

If the WD 22 is configured with DRX_IDLE cycle smaller or equal to 40.968. The Nₛₑᵣᵥ can be defined as follow.

TABLE 9
Another example of Nₛₑᵣᵥ for eDRX (e.g., shorter than 40.96 s)

| | Scaling Factor (N1) | | Nₛₑᵣᵥ [number of |
|---|---|---|---|
| eDRX cycle length [s] | FR1 | FR2^{Note1} | eDRX cycles] |
| 2.56 | 1 | 3 | N1*2 |
| 5.12 | | 2 | N1*2 |
| 10.24 | | 2 | N1*2 |
| 20.48 | | 2 | N1*2 |
| 40.96 | | 2 | N1*2 |

^{Note1}
Applies for WD supporting power class 2&3&4. For WD supporting power class 1, N1 = 4 for all DRX cycle length.

If the WD 22 is configured with eDRX_IDLE cycle larger than 40.96s. The Nₛₑᵣᵥ can be defined as follows.

TABLE 10
Another example of Nₛₑᵣᵥ for eDRX (e.g., larger than 40.96 s)

| | | PTW | |
|---|---|---|---|
| | DRX | length [s] | Nₛₑᵣᵥ [s] |
| | cycle | (number | (number |
| | length | of 1.28 s | of DRX |
| eDRX_IDLE cycle length [s] | [s] | periods) | cycles) ^{Note3} |
| 40.96 < eDRX_IDLE cycle | 0.32 | ≥1.28 (1) | M3*N3*2 |
| length ≤ 2621.44 | 0.64 | ≥2.56 (2) | M3*N3*2 |
| | 1.28 | ≥5.12 (4) | N3*2 |
| | 2.56 | ≥10.24 (8) | N3*2 |

NOTE 1:
The number of DRX cycles in this table is given for the DRX cycles within PTWs.
NOTE 2:
The eDRX_IDLE cycle lengths are as specified in Section 10.5.5.32 of TS 24.008.
^{NOTE3}
In FR1, N3 = 1. In FR2, N3 = 4 for power class 2&3&4, and N3 = 8 for power class 1.

### Step 2

In this step, the WD 22 performs one or more cell selection procedures for the selected PLMN if the WD 22 has not found any new suitable cell based on searches and measurements within the time period T.

Examples of cell selection procedures for the selected PLMN are:
WD 22 scans all RF channels in the NR bands according to its capabilities to find or detect a suitable cell; and/or
WD 22 uses stored information of frequencies and/or information on cell parameters from previously received measurement control information elements and/or from previously detected cells for selecting a cell.

The time T is expressed by a general function as follows:

$$T = f 2 ( μ , G , {T}_{DRX} , {T}_{eDRX} )$$

Examples of functions are maximum, average, sum, product, minimum, ceil, floor, etc., and any combinations of such functions.

If the WD 22 is configured with eDRX_IDLE cycle smaller or equal to 10.24s,

In one example assume μ=10 s and G=N3*K3, T can be expressed as follows:

$$T = max ( 10 s , N 3 * K 3 * {T}_{eDRX} ) ,$$

where, N3=1 for FR1 serving cell. In FR2, for WD support power class 2&3&4, N3=3 for Te_{DRX}=0.32s, and 2 for Te_{DRX}=5.12, 10.24s. In FR2, for WD support power class 1, N3=4. K3=4.

In another example,

$$T = max ( 10 s , N 4 * K 3 * {T}_{eDRX} + J 3 * {T}_{eDRX} ) ,$$

where, N3=1 for FR1 serving cell. In FR2, for WD support power class 2&3&4, N3=3 for Te_{DRX}=0.32s, and 2 for Te_{DRX}=5.12, 10.24s. In FR2, for WD support power class 1, N3=4. K3=2. J3=2.

If the WD 22 is configured with eDRX_IDLE cycle larger than 10.24s, in one example,

$$T = max ( 10 s , L 3 * {T}_{eDRX} cycles ) ,$$

where, L3=1.

In another example,

$$T = max ( 10 s , L 3 * {T}_{eDRX} cycles ) ,$$

where,

$$L 3 = ⌈ \frac{N 1 * 2}{PTW / DRX} ⌉ .$$

In some embodiments, FR2 cell reselection in Idle mode is described. The WD may initiate cell selection processes/procedures for a selected PLMN after 10s. However, considering Rx beam sweeping factor N1 in FR2, the evaluation time Nₛₑᵣᵥ is fairly larger than 10s, which implies the WD will initiate cell selection for the selected PLMN regardless of WD finishing once serving cell evaluation in FR2. Table 11 shows another example of Nₛₑᵣᵥ and scaling factor.

TABLE 11
Another example of Nserv and scaling factor.

| DRX cycle | Scaling Factor (N1) | | Nₛₑᵣᵥ [number of | Tₛₑᵣᵥ[s] for PC |
|---|---|---|---|---|
| length [s] | FR1 | FR2^{Note1} | DRX cycles] | 2&3&4 in FR2 |
| 0.32 | 1 | 8 | M1*N1*4 | 20.48(M1 = 2), |
| | | | | 10.24(M1 = 1) |
| 0.64 | | 5 | M1*N1*4 | 25.6(M1 = 2), |
| | | | | 12.8(M1 = 1) |
| 1.28 | | 4 | N1*2 | 10.24 |
| 2.56 | | 3 | N1*2 | 15.36 |

^{Note 1}
Applies for WD supporting power class 2&3&4. For WD supporting power class 1, N1 = 8 for all DRX cycle length.

A max function may be introduced, e.g., between the fixed value 10s and N1 scaling factor with DRX cycles. Additional details with respect to measurement and evaluation of serving cell(s) are as follows.

### Measurement and Evaluation of Serving Cell According to Some Embodiments

WD 22 shall/may measure SS-RSRP and SS-RSRQ level of a serving cell and evaluate the cell selection criterion S defined in TS 38.304 for the serving cell at least once every M1*N1 DRX cycle; where:
M1=2 if SMTC periodicity (T_{SMTC})>20 ms and DRX cycle≤0.64 second, otherwise M1=1.

WD 22 shall/may filter the SS-RSRP and SS-RSRQ measurements of the serving cell using at least two measurements. Within the set of measurements used for the filtering, at least two measurements shall/may be spaced by, at least DRX cycle/2.

If WD 22 has evaluated, e.g., according to Table 2 and/or Table 11, in Nₛₑᵣᵥ consecutive DRX cycles that the serving cell does not fulfil the cell selection criterion S, WD 22 shall/may initiate the measurements of all neighbor cells indicated by the serving cell, regardless of the measurement rules currently limiting WD measurement activities.

If WD 22 in RRC_IDLE has not found any new suitable cell based on searches and measurements using the intra-frequency, inter-frequency and inter-RAT information indicated in the system information for max (10 s, M1*N1*K1*DRX cycle), WD 22 shall/may initiate cell selection procedures for the selected PLMN as defined in 3GPP TS 38.304, where K1=[6] if DRX cycle is 0.32s or 0.64s, otherwise K1=[3].

In some embodiments, a measurement is performed after the WD 22 does not meet the cell selection criterion. In a nonlimiting example, WD 22 measures on a first cell (Cell1) and/or evaluates a cell selection criterion based on the first measurement. If WD 22 does not meet the cell selection criterion, WD 22 may initiate neighbor cell measurements, e.g., on a second cell (Cell2). If WD 22 cannot find any neighbor cell measurements such as on Cell2 during T2, WD 22 may initiate a cell selection procedure.

### Discussions on RedCap Mobility Requirements

3GPP RAN4 has discussed the impact on RRM requirements due to WD complexity reduction for last two meetings. At last meeting, specification impact to the following mobility requirements were identified:
Handover:
RRC re-establishment:
Random Access; and
RRC connection release with redirection.

In this contribution, detailed requirements for the above procedures for RedCap WD with 1 receive antenna are described.

### Handover

Handover requirements comprise two components: Dhandover and Tinterrupt. Dhandover is RRC processing delay defined in 3GPP TS 38.331. Tinterrupt is a maximum allowed interruption time allowed during the handover and is defined as follows for intra-frequency and inter-frequency handover:

$$Tinterrupt = Tsearch + TIU + Tprocessing + T Δ + Tmargin ms ,$$

Where:
Tsearch is the time required to search a target cell when the target cell is not already known when the handover command is received by the WD 22. If the target cell is known, then Tsearch=0 ms. If the target cell is an unknown intra-frequency cell and the target cell Es/Iot>−2 dB, then Tsearch=Trs ms. If the target cell is an unknown inter-frequency cell and the target cell Es/Iot>−2 dB, then Tsearch=3*Trs ms.
TΔ is time for fine time tracking and acquiring full timing information of the target cell. TΔ=Trs.
Tprocessing is time for WD processing.
Tmargin is time for SSB post-processing
TIU is the interruption uncertainty in acquiring the first available

PRACH occasion in the new cell. TIU can be up to the summation of SSB to Packet/Physical Random Access Channel (PRACH) occasion association period and 10 ms.
Trs is the SMTC periodicity of the target NR cell if the WD 22 has been provided with an SMTC configuration for the target cell in the handover command. Otherwise, Trs is the SMTC configured in the measObjectNR having the same SSB frequency and subcarrier spacing.

According to 3GPP RAN2 agreements, the RRC processing delay from legacy NR is reused for RedCap WDs with 1 and 2 receive branches, and thus no impact on is expected for RedCap.
Observation #1: RRC processing delay for RedCap is reused from rel-15 NR.

Out of the other delay components in Tᵢₙₜₑᵣᵣᵤₚₜ, only T_{search} might be impacted due to 1 rx. No impact is expected on T_{margin}, T_{IU}, T_{Δ} and Tᵣₛ. Regarding T_{search}. 3GPP RAN4 is currently studying the cell detection performance for RedCap 1 rx WD, whether T_{search} is extended for RedCap 1 rx WD shall be decided based on the outcome of that simulation study. For the RedCap WD with 2 rx, the existing requirements on T_{search} is reused as agreed at previous meeting.
Observation #2: Out of the delay components in Handover (HO) requirements, only the time required to search the target cell (T_{search}) might be impacted due to 1 rx for RedCap.
Proposal #1: The outcome of the cell detection performance study is used to determine whether the T_{search} in handover requirements is extended for RedCap 1 rx UE.

Current specification contains handover requirements for following types of handovers:
NR FR1-NR FR1 Handover
NR FR2-NR FR1 Handover
NR FR2-NR FR2 Handover
NR FR1-NR FR2 Handover
NR-E-UTRAN Handover

The same types of handovers may also be supported also for the RedCap WDs. Thus, following proposal is made:
Proposal #2: 3GPP RAN4 to develop the handover requirements for RedCap with 1 rx and 2 rx for following types of handovers:
NR FR1-NR FR1 Handover
NR FR2-NR FR1 Handover
NR FR2-NR FR2 Handover
NR FR1-NR FR2 Handover
NR-E-UTRAN Handover

The inter-RAT handover to E-UTAN is defined similar to NR as shown above, but Tᵢₙₜₑᵣᵣᵤₚₜ is defined differently as shown below:

$${T}_{interrupt} = {T}_{search} + {T}_{IU} + 20 ms$$

For the inter-RAT handover, following the agreement from previous meeting 3GPP RAN4 shall reuse the requirements (T_{search} and T_{IU}) from existing specification 3GPP TS 38.133 and cat-1bis requirements from 3GPP TS 36.133 for RedCap WD with 2 rx and 1 rx respectively.
Proposal #3: For inter-RAT handover to E-UTRAN, the existing requirements from 3GPP TS 38.133 and cat-1bis requirements in 3GPP TS 36.133 are reused for RedCap WD with 2 rx and 1 rx respectively.

It is FFS whether conditional handover (CHO) is going to be supported for RedCap. Therefore, 3GPP RAN4 discussions related to CHO should be postponed.
Proposal #4: RAN4 discussions on CHO requirements for RedCap should be postponed.

### RRC Re-Establishment

RRC re-establishment requirements are defined in terms of maximum time within with the WD shall be capable of sending RRCReestablishmentRequest message upon WD detects a loss in RRC connection. The maximum time is defined as follows:

$${T}_{re - establish \_ delay} = {T}_{UE \_ re - establish \_ delay} + {T}_{UL \_ grant}$$

T_{UL_grant} is the time required to acquire and process uplink grant from the target PCell and T_{UE_re-establish_delay} comprises multiple delay components as show below:

$${T}_{UE \_ re - establish \_ delay} = 50 ms + {T}_{identify \_ intra \_ NR} + {\sum }_{i = 1}^{{N}_{freq} - 1} {T}_{indentify \_ inter \_ NR , i} + {T}_{SI - NR} + {T}_{PRACH}$$

where
T_{identify_intra_NR}: the time required to identify the target intra-frequency NR cell:
T_{identify_inter_NR,i}: the time required to identify the target inter-frequency NR cell:
T_{SI-NR}: It is the time required for receiving all the relevant system information according to the reception procedure and the RRC procedure delay of system information blocks defined in 3GPP TS 38.331 for the target NR cell:
T_{PRACH}: It is the delay uncertainty in acquiring the first available PRACH occasion in the target NR cell. T_{PRACH} can be up to the summation of SSB to PRACH occasion association period and 10 ms; and/or
N_{freq}: It is the total number of NR frequencies to be monitored for RRC re-establishment.

In the formula above, it is expected that T_{identify_intra_NR}, T_{identify_inter_NR,I} and T_{SI-NR} are impacted due to due to 1 rx operation. For the T_{search} parts (intra- and inter-frequency), 3GPP RAN4 is currently studying the cell detection performance for

RedCap 1 rx WD, whether T_{search} is extended for RedCap 1 rx WD shall be decided based on the outcome of that simulation study. The current definitions of known/unknown cells as well as side conditions can be reused for RedCap. Regarding the impact on T_{SI-NR}, RAN4 agreed on simulation assumptions at last meeting to study the potential impact due to 1 rx operation. The outcome of that study should be used for deciding whether T_{SI-NR} is extended for RedCap 1 rx WD.
Observation #3: Out of the delay components in RRC re-establishment requirements, T_{identify_intra_NR}, T_{identify_inter_NR,I} and T_{SI-NR} might be impacted due to 1 rx operation for RedCap:
Observation #4: Current definitions of known/unknown cells and side conditions in the RRC re-establishment requirements can be reused for RedCap:
Proposal #5: The outcome of the cell detection performance study is used to determine whether T_{identify_intra_NR} and T_{identify_inter_NR,I} in the RRC re-establishment requirements are extended for RedCap UE with 1 rx; and/or
Proposal #6: The outcome of the PBCH detection performance study is used to determine whether T_{SI-NR} in the RRC re-establishment requirements is extended for RedCap UE with 1 rx.

### Random Access

Physical design and procedures of random access remain unchanged for RedCap. Therefore, it is possible to apply the current requirements for RedCap WD operating in Full Duplex (FD)-Frequency Division Duplex (FDD) and Time Division Duplex (TDD) mode. However, Half Duplex (HD)-FDD mode is introduced in 3GPP Release 17 and needs careful consideration as explained below.
Proposal #7: Current Random Access (RA) requirements are applicable for RedCap WDs in FD-FDD and TDD mode.

### RA for HD-FDD WD

Before initiating the random access, the WD needs to be synchronized towards the target cell and SS/PBCH or TRS are used for performing the resynchronization (time/frequency tracking and AGC). Even if the WD is operating in half-duplex FDD (HD-FDD) mode, the gNB still operates in full-duplex FDD (FD-FDD) mode. Therefore, overlapping between DL reception and UL transmission may occur for HD-FDD WD since it cannot perform both operations in parallel and gNB cannot always avoid such conflict with scheduling. As a consequence of the overlapping, the WD may fail to perform the resynchronization before transmitting the random access preamble in Msg1 or MsgA, depending on the RA type. In addition, the WD needs to perform a RSRP measurement before initiating the RA for selecting between 2-step RA and 4-step RA, if both RA types are configured. Since resynchronization is WD implementation specific, for instance what type of RS (SSB or TRS), the number of RS, and when it should receive those varies with the implementation. Therefore, RAN4 should clarify that the WD is not expected to perform PRACH transmission in a cell if the WD cannot receive at least one SSB during the last Tp period before the PRACH transmission occasion, where exact value of Tp can be further discussed, e.g. Tp=160 ms.
Proposal #8: The RedCap WD operating in HD-FDD mode is not expected to perform PRACH transmission in a cell if WD has not received at least one SSB during the last Tp period in the cell, where
   Option 1: Tp=160 ms.
Proposal #9: The RedCap WD operating in HD-FDD mode shall meet the PRACH requirements when performing PRACH transmission in a cell provided that the WD has received at least one SSB during the last Tp period before the PRACH transmission, where
   Option 1: Tp=160 ms.

### Impact on Measurement Accuracy on RA

The RedCap WD may support 1 Rx or 2 Rx or different number of Rx depending on the band. The number of WD receivers (1 Rx or 2 Rx) will be Redcap WD capability. For example, one RedCap WD may indicate support for 1 Rx while another RedCap WD may indicate support for 2 Rx even for the same band. Therefore, in the same cell there can be RedCap WDs with some supporting 1 Rx or some supporting 2 Rx. Furthermore, in the same cell there can be redcap WDs supporting 1 Rx as well as normal/legacy NR WDs supporting 2 Rx. RAN4 has agreed to study the RRM measurement performance for the 1 Rx case. We have provided our simulation results in a companion paper where a considerably higher measurement bias is observed with 1 Rx compared to 2 Rx. Thus, discussions are ongoing to relax RSRP accuracy requirements for 1 Rx WD compared to 2 Rx WD, e.g., relaxation by 1.5 dB-2 dB can be considered.

According to current procedures RSRP based thresholds are used in various requirements such as RA. For instance, in current RA requirements, when both 4-step RA and 2-step RA are configured then the WD selects 2-step RA if the RSRP of the reference SSB is above RSRP threshold (msgA-RSRP-Threshold); otherwise, the WD selects 4-step RA. Since all legacy WDs support 2 Rx therefore RSRP measurements are performed with 2 Rx, therefore only a single RSRP threshold is used for the RA selection or for any other procedure using RSRP threshold. However, since there will be some WDs operating with both 1 Rx (RedCap WDs) and 2 Rx (e.g., legacy NR WDs) in same cell, therefore two different RSRP thresholds would be needed to avoid network performance degradation, e.g., WDs incorrectly selecting 4-step RA instead 2-step RA and vice versa, avoiding coverage holes etc. At least in RRC idle/inactive states, the gNB needs to signal two different RSRP thresholds. The RSRP threshold range can be the same for both cases. When comparing to Cat-M or NB-IoT, all those WDs were operating with 1 Rx and thus a single threshold was used which is derived based on the 1 Rx measurement performance. RedCap, on the other hand, may need two different RSRP thresholds that are derived and configured by gNB based on 1 Rx- and 2 Rx measurement accuracy performance.

The following list of RSRP based thresholds are used in legacy NR requirements and need new thresholds based on 1 Rx measurement performance: rsrp-ThresholdSSB, rsrp-ThresholdCSI-RS, msgA-RSRP-ThresholdSSB, rsrp-ThresholdSSB-SUL, msgA-RSRP-Threshold.

Since thresholds are discussed in RAN2, RAN4 should inform RAN2 about the need to introduce a separate RSRP thresholds for RedCap 1 Rx WD in procedures that depend on RSRP thresholds.
Observation #5: RSRP based thresholds assuming 2 Rx WDs are used in various procedures in current specification including: rsrp-ThresholdSSB, rsrp-ThresholdCSI-RS, msgA-RSRP-ThresholdSSB, rsrp-ThresholdSSB-SUL, msgA-RSRP-Threshold:
Observation #6: RSRP measurement accuracy is considerably degraded for 1 Rx WD compared to 2 Rx WD for RedCap; and
Proposal #10: Inform RAN2 about the need to introduce separate RSRP thresholds for RedCap WD with 1 Rx in procedures that depend on RSRP based thresholds such as RA.
   RRC Connection Release with Redirection

Current specification contains requirements for RRC connection release with redirection to NR and E-UTRAN cells. After receiving the last slot containing the RRCRelease message, the WD shall transmit the random access on the target cell within T_{connection_release_redirect_NR} for NR cell and within T_{connection_release_redirect_E-UTRA} for E-UTRA cell where:

$${T}_{connection \_ release \_ redirect \_ NR} = {T}_{RRC \_ procedure \_ delay} + {T}_{identify - NR} + {T}_{SI - NR} + {T}_{RACH}$$

$${T}_{connection \_ release \_ redirect \_ E - UTRA} = {T}_{RRC \_ procedure \_ delay} + {T}_{identify - E - UTRA} + {T}_{SI - E - UTRA} + {T}_{RACH}$$

Similar to the earlier discussions on handover and RRC re-establishment, T_{RRC_procedure_delay} is not impacted due to RedCap as per RAN2 agreements. However, T_{identify-NR} and T_{identify-E-UTRA} might be impacted due to 1 rx. RAN4 is currently studying the cell detection performance for 1 rx and the outcome of that study can be used to decide whether the T_{identify-NR} is extended. However, for the RRC connection release with redirection to E-UTRA cell, T_{identify-E-UTRA} and T_{SI-E-UTRA} requirements from the existing specifications in TS 38.133 and cat-1bis requirements in 3GPP TS 36.133 are reused for 2 rx and 1 rx WD respectively.

TRACH is the delay uncertainty in acquiring the first available PRACH occasion in the target NR cell. For the redirection to E-UTRA cell, TRACH is the delay caused due to the random access procedure when sending random access to the target E-UTRA cell. In both cases, no impact is expected on these parameters due to 1 rx operation since the physical design of RACH is same as in legacy NR.
Observation #7: Out of the delay components in RRC connection release with redirection requirements, T_{identify-NR} and T_{SI-NR} might be impacted due to 1 rx operation for RedCap when target cell is a NR cell;
Observation #8: Out of the delay components in RRC connection release with redirection requirements, T_{identify-E-UTRA} and T_{SI-E-UTRA} might be impacted due to 1 rx operation for RedCap when target cell is a E-UTRA cell;
Proposal #11: The outcome of the cell detection performance study is used to determine whether T_{identify-NR} in the RRC connection release with redirection to NR cell requirements needs to be extended for RedCap WD with 1 rx:
Proposal #12: The outcome of the PBCH detection performance study is used to determine whether T_{SI-NR} in the RRC connection release with redirection to NR cell requirements needs to be extended for RedCap WD with 1 rx; and
Proposal #13: For the RRC connection release with direction to E-UTRA cell, T_{identify-E-UTRA} and T_{SI-E-UTRA} from existing specification in TS 38.133 and cat-1bis requirements in 3GPP TS 36.133 are reused for 2 rx and 1 rx WD respectively.

In sum, in this contribution, the mobility requirements for RedCap have been described. Further, the impact on handover, RRC re-establishment, random access and RRC connection release with redirection have been analyzed. Observations and proposals are summarized as follows:
Observation #1: RRC processing delay for RedCap is reused from rel-15 NR:
Observation #2: Out of the delay components in HO requirements, only the time required to search the target cell (T_{search}) might be impacted due to 1 rx for RedCap;
Proposal #1: The outcome of the cell detection performance study is used to determine whether the T_{search} in handover requirements is extended for RedCap 1 rx WD:
Proposal #2: RAN4 to develop the handover requirements for RedCap with 1 rx and 2 rx for following types of handovers:
   NR FR1-NR FR1 Handover
   NR FR2-NR FR1 Handover
   NR FR2-NR FR2 Handover
   NR FR1-NR FR2 Handover
   NR-E-UTRAN Handover.
Proposal #3: For inter-RAT handover to E-UTRAN, the existing requirements from TS 38.133 and cat-1bis requirements in TS 36.133 are reused for RedCap WD with 2 rx and 1 rx respectively:
Proposal #4: RAN4 discussions on CHO requirements for RedCap should be postponed:
Observation #3: Out of the delay components in RRC re-establishment requirements, T_{identify_intra_NR}, T_{identify_inter_NR,I} and T_{SI-NR} might be impacted due to 1 rx operation for RedCap:
Observation #4: Current definitions of known/unknown cells and side conditions in the RRC re-establishment requirements can be reused for RedCap:
Proposal #5: The outcome of the cell detection performance study is used to determine whether T_{identify_intra_NR} and T_{identify_inter_NR,I} in the RRC re-establishment requirements are extended for RedCap WD with 1 rx:
Proposal #6: The outcome of the PBCH detection performance study is used to determine whether T_{SI-NR} in the RRC re-establishment requirements is extended for RedCap WD with 1 rx:
Proposal #7: Current RA requirements are applicable for RedCap WDs in FD-FDD and TDD mode;
Proposal #8: The RedCap WD operating in HD-FDD mode is not expected to perform PRACH transmission in a cell if WD has not received at least one SSB during the last Tp period in the cell, where
   Option 1: Tp=160 ms.
Proposal #9: The RedCap WD operating in HD-FDD mode shall meet the PRACH requirements when performing PRACH transmission in a cell provided that the WD has received at least one SSB during the last Tp period before the PRACH transmission, where
   Option 1: Tp=160 ms.
Observation #5: RSRP based thresholds assuming 2 Rx WDs are used in various procedures in current specification including: rsrp-ThresholdSSB, rsrp-ThresholdCSI-RS, msgA-RSRP-ThresholdSSB, rsrp-ThresholdSSB-SUL, msgA-RSRP-Threshold;
Observation #6: RSRP measurement accuracy is considerably degraded for 1 Rx WD compared to 2 Rx WD for RedCap;
Proposal #10: Inform RAN2 about the need to introduce separate RSRP thresholds for RedCap WD with 1 Rx in procedures that depend on RSRP based thresholds such as RA:
Observation #7: Out of the delay components in RRC connection release with redirection requirements, T_{identify-NR} and T_{SI-NR} might be impacted due to 1 rx operation for RedCap when target cell is a NR cell:
Observation #8: Out of the delay components in RRC connection release with redirection requirements, T_{identify-E-UTRA} and T_{SI-E-UTRA} might be impacted due to 1 rx operation for RedCap when target cell is a E-UTRA cell;
Proposal #11: The outcome of the cell detection performance study is used to determine whether T_{identify-NR} in the RRC connection release with redirection to NR cell requirements needs to be extended for RedCap WD with 1 rx:
Proposal #12: The outcome of the PBCH detection performance study is used to determine whether T_{SI-NR} in the RRC connection release with redirection to NR cell requirements needs to be extended for RedCap WD with 1 Ix; and,
Proposal #13: For the RRC connection release with direction to E-UTRA cell,
T_{identify-E-UTRA} and T_{SI-E-UTRA} from existing specification in TS 38.133 and cat-1bis requirements in TS 36.133 are reused for 2 rx and 1 rx WD, respectively.
LS on RSRP based thresholds for RedCap WD with 1 Rx; Work item: NR redcap-Core; RAN WG4; RAN WG2

### Overall Description

3GPP RAN4 has studied RSRP measurement performance for RedCap WD with 1 Rx and has found that the measurement accuracy is degraded by [1.5 dB-2.0 dB] for 1 Rx WD compared to 2 Rx WD. The Redcap WDs supporting 1 Rx may coexist with legacy NR WDs supporting 2 Rx in the same cell. Therefore, 3GPP RAN4 has further discussed its impact and identified the need to introduce separate RSRP based threshold for Redcap WD supporting 1 Rx for a procedure based on comparison of the RSRP with RSRP threshold. The range of the new RSRP threshold for RedCap WD supporting 1 Rx can be the same as used for the existing RSRP threshold for the WDs with 2 Rx WD i.e. legacy NR WD or RedCap WD supporting 2 Rx.

3GPP RAN4 therefore requests 3GPP RAN2 to introduce signaling support to configure separate RSRP thresholds for RedCap WD with 1 Rx for following list of thresholds which are used in their current specifications, e.g., 3GPP TS 38.331, 3GPP TS 38.321, etc.:
rsrp-ThresholdSSB:
rsrp-ThresholdCSI-RS:
msgA-RSRP-ThresholdSSB:
rsrp-ThresholdSSB-SUL; and
msgA-RSRP-Threshold.

### To Ran WG2 Group.

ACTION: 3GPP RAN4 asks 3GPP RAN2 to:
Introduce signaling support to configure separate RSRP based thresholds for RedCap WD supporting 1 Rx for following list of thresholds:
   rsrp-ThresholdSSB;
   rsrp-ThresholdCSI-RS:
   msgA-RSRP-ThresholdSSB;
   rsrp-ThresholdSSB-SUL; and
   msgA-RSRP-Threshold.
The range of the RSRP threshold for RedCap WD supporting 1 Rx can be the same as used for the existing RSRP threshold for the WDs with 2 Rx WD, i.e., legacy NR WD.

The following is a nonlimiting list of example embodiments:

1. A network node configured to communicate with a wireless device, WD 22, the WD 22 being configurable to operate in a discontinuous reception mode, the network node 16 comprising processing circuitry 36 configured to:
cause the WD 22 to determine a cell selection process for a network based at least in part on whether at least one cell meets at least one cell selection condition within a time period, the at least one cell being operated by the network node 16.

2. The network node 16 of Embodiment 1, wherein the processing circuitry 36 is further configured to:
trigger the WD 22 to be configured to operate in the discontinuous reception mode, operating in the discontinuous reception mode causing the WD 22 to perform a cell measurement associated with the at least one cell associated with the network node 16 including determining at least a measurement requirement within a number of cycles, Nₛₑᵣᵥ, of the discontinuous reception mode.

3. The network node 16 of any one of Embodiments 1 and 2, wherein determining the cell selection process includes measuring at least one other cell that is a neighbor cell to the at least one cell.

4. The network node 16 of any one of Embodiments 1-3, wherein determining the cell selection process includes at least one of:
scanning at least a communication channel in a frequency band to determine another cell meets the least one cell selection condition; and
using information associated with at least one of received measurement control information elements and previously detected cells to determine the other cell meets the least one cell selection condition.

5. The network node 16 of any one of Embodiments 1-4, wherein determining whether the at least one cell meets the at least one cell selection condition within a time period includes determining that the at least once cell is not a suitable cell based at least in part on a cell search and a cell measurement.

6. The network node 16 of any one of Embodiments 1-5, wherein the at least one cell selection condition is based on at least one of an idle cycle length, a beam scaling factor, a monitoring window, an extended idle cycle length associated with the discontinuous reception mode.

7. The network node 16 of any one of Embodiments 1-6, wherein the at least one cell is a serving cell.

8. The network node 16 of any one of Embodiments 1-7, wherein the network is a Public Land Mobile Network, PLMN.

9 The network node 16 of any one of Embodiments 1-8, wherein the discontinuous reception mode is any one of a Discontinuous Reception, DRX, and an extended Discontinuous Reception, DRX.

10. The network node 16 of any one of Embodiments 1-9, wherein the WD 22 is a reduced capability, RedCap, device.

11. A method implemented in network node 16 configured to communicate with a wireless device, WD 22, the WD 22 being configurable to operate in a discontinuous reception mode, the method comprising:
causing, S100, the WD 22 to determine a cell selection process for a network based at least in part on whether at least one cell meets at least one cell selection condition within a time period, the at least one cell being operated by the network node 16.

12. The method of Embodiment 11, wherein method further includes:
triggering the WD 22 to be configured to operate in the discontinuous reception mode, operating in the discontinuous reception mode causing the WD 22 to perform a cell measurement associated with the at least one cell associated with the network node 16 including determining at least a measurement requirement within a number of cycles, Nₛₑᵣᵥ, of the discontinuous reception mode.

13. The method of any one of Embodiments 11 and 12, wherein determining the cell selection process includes measuring at least one other cell that is a neighbor cell to the at least one cell.

14. The method of any one of Embodiments 11-13, wherein determining the cell selection process includes at least one of:
scanning at least a communication channel in a frequency band to determine another cell meets the least one cell selection condition; and
using information associated with at least one of received measurement control information elements and previously detected cells to determine the other cell meets the least one cell selection condition.

15. The method of any one of Embodiments 11-14, wherein determining whether the at least one cell meets the at least one cell selection condition within a time period includes determining that the at least once cell is not a suitable cell based at least in part on a cell search and a cell measurement.

16. The method of any one of Embodiments 11-15, wherein the at least one cell selection condition is based on at least one of an idle cycle length, a beam scaling factor, a monitoring window, an extended idle cycle length associated with the discontinuous reception mode.

17. The method of any one of Embodiments 11-16, wherein the at least one cell is a serving cell.

18. The method of any one of Embodiments 11-17, wherein the network is a Public Land Mobile Network, PLMN.

19. The method of any one of Embodiments 11-18, wherein the discontinuous reception mode is any one of a Discontinuous Reception, DRX, and an extended Discontinuous Reception, DRX.

20. The method of any one of Embodiments 11-19, wherein the WD 22 is a reduced capability, RedCap, device.

21. A wireless device, WD 22. configured to communicate with a network node 16, the WD 22 being configurable to operate in a discontinued reception mode and comprising processing circuitry 50 configured to:
perform a cell measurement associated with at least one cell associated with the network node; and
determine a cell selection process for a network based at least in part on whether the at least one cell meets at least one cell selection condition within a time period.

22. The WD 22 of any one of Embodiment 21, wherein performing the cell measurement includes determining at least a measurement requirement within a number of cycles, Nₛₑᵣᵥ, of the discontinued reception mode.

23. The WD 22 of any one of Embodiments 21 and 22, wherein determining the cell selection process includes measuring at least one other cell that is a neighbor cell to the at least one cell.

24. The WD 22 of any one of Embodiments 21-23, wherein determining the cell selection process includes at least one of:
scanning at least a communication channel in a frequency band to determine another cell meets the least one cell selection condition; and
using information associated with at least one of received measurement control information elements and previously detected cells to determine the other cell meets the least one cell selection condition.

25. The WD 22 of any one of Embodiments 21-24, wherein determining whether the at least one cell meets the at least one cell selection condition within a time period includes determining that the at least once cell is not a suitable cell based at least in part on a cell search and a cell measurement.

26. The WD 22 of any one of Embodiments 21-25, wherein the at least one cell selection condition is based on at least one of an idle cycle length, a beam scaling factor, a monitoring window, an extended idle cycle length associated with the discontinued reception mode

27. The WD 22 of any one of Embodiments 21-26, wherein the at least one cell is a serving cell.

28. The WD 22 of any one of Embodiments 21-27, wherein in the network is a Public Land Mobile Network, PLMN.

29. The WD 22 of any one of Embodiments 21-28, wherein the discontinuous reception mode is any one of a Discontinuous Reception, DRX, and an extended Discontinuous Reception, DRX.

30. The WD 22 of any one of Embodiments 21-29, wherein the WD 22 is a reduced capability, RedCap, device.

31. A method implemented in a wireless device, WD, (22) configured to communicate with a network node 16, the WD 22 being configurable to operate in a discontinued reception mode, the method comprising:
performing, S102, a cell measurement associated with at least one cell associated with the network node; and
determining, S104, a cell selection process for a network based at least in part on whether the at least one cell meets at least one cell selection condition within a time period.

32. The method of Embodiment 31, wherein performing the cell measurement includes determining at least a measurement requirement within a number of cycles, Nₛₑᵣᵥ, of the discontinued reception mode.

33. The method of any one of Embodiments 31 and 22, wherein determining the cell selection process includes measuring at least one other cell that is a neighbor cell to the at least one cell.

34. The method of any one of Embodiments 31-33, wherein determining the cell selection process includes at least one of:
scanning at least a communication channel in a frequency band to determine another cell meets the least one cell selection condition; and
using information associated with at least one of received measurement control information elements and previously detected cells to determine the other cell meets the least one cell selection condition.

35. The method of any one of Embodiments 31-34, wherein determining whether the at least one cell meets the at least one cell selection condition within a time period includes determining that the at least once cell is not a suitable cell based at least in part on a cell search and a cell measurement.

36. The method of any one of Embodiments 31-35, wherein the at least one cell selection condition is based on at least one of an idle cycle length, a beam scaling factor, a monitoring window, an extended idle cycle length associated with the discontinued reception mode

37. The method of any one of Embodiments 31-36, wherein the at least one cell is a serving cell.

38. The method of any one of Embodiments 31-37, wherein in the network is a Public Land Mobile Network, PLMN.

39. The method of any one of Embodiments 31-38, wherein the discontinuous reception mode is any one of a Discontinuous Reception, DRX, and an extended Discontinuous Reception, DRX.

40. The method of any one of Embodiments 31-39, wherein the WD 22 is a reduced capability, RedCap, device.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G 5th Generation mobile networks
5GS 5G system
CGI Cell Global Identifier
eDRX Extended DRX
eNB Base station in LTE
gNB Base station in NR
LTE Long Term Evolution
MAC Medium Access Control
MBB Mobile Broadband
MIMO Multiple Input Multiple Output
MTC Machine Type Communication
NG Next Generation
NR New Radio
PDCP Packet Data Convergence Protocol
RAN Radio Access Network
RedCap Reduced Capability
RLC Radio Link Control
RMC Relaxed Measurement Criteria
RRC Radio Resource Control
RRM Radio Resource Management
UE User Equipment (Wireless device in 3GPP systems)
URLLC Ultra Reliable Low Latency Communication

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-22. (canceled)

23. A wireless device, WD, configured to communicate with a network node, the WD being configurable to operate in a discontinued reception mode, the discontinued reception mode comprising at least one of a discontinued reception cycle, DRX, and an extended discontinued reception cycle, eDRX, the WD comprising processing circuitry configured to:
perform a second measurement associated with at least one second cell, Cell2, associated with the network node if the WD does not meet a cell selection criterion for a first cell, Cell1; and
perform a cell selection procedure for a network if the WD has not found at least one suitable cell based on the performed second measurement within a second time period, the second time period, being based at least in part on a scaling factor.

24. The WD of claim 23, wherein the processing circuitry is further configured to:
perform a first measurement on Cell1; and
evaluate whether the WD meets the cell selection criterion for Cell1 based on the first measurement performed on Cell1 within a first time period.

25. The WD of claim 24, wherein the performing of the first measurement on Cell1 includes determining at least a measurement requirement is within a number of cycles, Nserv, of the discontinued reception mode.

26. The WD of claim 23, wherein the second time period is further based on at least one of:
a length of the DRX;
a length of the eDRX; and
a frequency range, FR.

27. The WD of claim 26, wherein the processing circuitry is further configured to:
adjust the scaling factor to meet a paging time window, PTW, condition, the PTW condition being a PTW is shorter than the length of the eDRX;
extend a monitoring window with multiple eDRX cycles; and
extend the length of the eDRX without the PTW.

28. The WD of claim 23, wherein the scaling factor comprises at least one of:
a beam sweeping factor;
another factor based on a length of the DRX and a reference signal periodicity; and
a power class of the WD.

29. (canceled)

30. The WD of claim 23, wherein the performing of the cell selection procedure includes:
scanning at least a communication channel in a frequency band to determine whether the at least one suitable cell has been found based on at least the performed second measurement, the at least one suitable cell meeting at least one cell selection condition.

31. The WD of claim 23, wherein the performing of the cell selection procedure for the network includes:
determining that the at least one cell is not the at least one suitable cell based at least in part on a cell search and the second measurement.

32. The WD of claim 23, wherein the processing circuitry (50) is further configured to at least one of perform the second measurement and perform the cell selection procedure based on a configuration received from the network node (16).

33. The WD of claim 23, wherein at least one of:
the first cell, Cell1, is a serving cell;
the at least one second cell, Cell2, is a neighbor cell;
the network is a Public Land Mobile Network, PLMN; and
the WD is a reduced capability, RedCap, device.

34. A method in a wireless device, WD, configured to communicate with a network node, the WD being configurable to operate in a discontinued reception mode, the discontinued reception mode comprising at least one of a discontinued reception cycle, DRX, and an extended discontinued reception cycle, eDRX, the method comprising:
performing a second measurement associated with at least one second cell, Cell2, associated with the network node if the WD does not meet a cell selection criterion for a first cell, Cell1; and
performing a cell selection procedure for a network if the WD has not found at least one suitable cell based on the performed second measurement within a second time period, the second time period, being based at least in part on a scaling factor.

35. The method of claim 34, wherein the method further comprises:
performing a first measurement on Cell1; and
evaluating whether the WD meets the cell selection criterion for Cell1 based on the first measurement performed on Cell1 within a first time period.

36. The method of claim 35, wherein the performing of the first measurement on Cell1 includes determining at least a measurement requirement is within a number of cycles, Nₛₑᵣᵥ, of the discontinued reception mode.

37. The method of claim 34, wherein the second time period is further based on at least one of:
a length of the DRX;
a length of the eDRX; and
a frequency range, FR.

38. The method of claim 37, wherein the method further includes:
adjusting the scaling factor to meet a paging time window, PTW, condition, the PTW condition being a PTW is shorter than the length of the eDRX;
extending a monitoring window with multiple eDRX cycles; and
extending the length of the eDRX without the PTW.

39. The method of claim 34, wherein the scaling factor comprises at least one of:
a beam sweeping factor;
another factor based on a length of the DRX and a reference signal periodicity; and
a power class of the WD.

40. (canceled)

41. The method of claim 34, wherein the performing of the cell selection procedure includes:
scanning at least a communication channel in a frequency band to determine whether the at least one suitable cell has been found based on at least the performed second measurement, the at least one suitable cell meeting at least one cell selection condition.

42. The method of claim 34, wherein the performing of the cell selection procedure for the network includes:
determining that the at least one cell is not the at least one suitable cell based at least in part on a cell search and the second measurement.

43. The method of claim 34, wherein the method further includes at least one of performing the second measurement and performing the cell selection procedure based on a configuration received from the network node.

44. The method of claim 34, wherein at least one of:
the first cell, Cell1, is a serving cell;
the at least one second cell, Cell2, is a neighbor cell;
the network is a Public Land Mobile Network, PLMN; and
the WD is a reduced capability, RedCap, device.
